(19) United States
(12) Patent Application Publication
(10) Pub. No.: US 2007/0171288 A1
(43) Pub. Date: Jul. 26, 2007

(54) Image correction apparatus and method, image correction database creating method, information data provision apparatus, image processing apparatus, information terminal, and information database apparatus

(76) Inventors: Yasuaki Inoue, Osaka (JP); Akiomi Kunisa, Tokyo (JP); Kenichiro Mitani, Osaka (JP); Kousuke Tsujita, Saitama (JP); Satoru Takeuchi, Osaka (JP)

Correspondence Address: MCDERMOTT WILL & EMERY LLP, 600 13TH STREET, N.W., WASHINGTON, DC, 20005-3096, US

(21) Appl. No.: 10/594,151

(22) PCT Filed: Mar. 1, 2005
(86) PCT No.: PCT/JP05/03398

§ 371 Date: Sep. 25, 2006

(30) Foreign Application Priority Data
Mar. 25, 2004 (JP) 2004-089684
Jun. 23, 2004 (JP) 2004-185659
Nov. 12, 2004 (JP) 2004-329826

(51) Int. Cl. H04N 5/217

(52) U.S. Cl. 348/241

(57) ABSTRACT

A capturing unit captures and digitizes a printed image having an electronic watermark embedded therein and a lattice pattern image. A profile creation unit detects position deviations of intersections in the lattice pattern images captured at respective different zoom magnifications, generates correction information on distortion occurring in the images, and registers the correction information into a profile database in association with the zoom magnifications. An image correction unit selects correction information corresponding to a zoom magnification employed at the time of capturing of the printed image from the profile database, and corrects distortion occurring in the captured image of the printed image. An image area determination unit determines an original image area in the distortion-corrected captured image. A watermark extraction unit extracts watermark information from the original image area in the distortion-corrected captured image.

### TECHNICAL FIELD

The invention relates to image processing technologies, and more particularly to an image correction apparatus and a method for correcting images, and an image correction database creating method of that apparatus. The present invention also relates to an information data provision apparatus, an image processing apparatus, an information terminal, and an information database apparatus.

### BACKGROUND TECHNOLOGY

There are systems in which digital images having electronic watermarks embedded therein are printed on printing media, and the printed images are captured by a digital camera, a scanner, or the like and re-digitized to detect the embedded electronic watermarks. For example, when issuing tickets or cards to users, identification information on the issuers and/or the users is embedded into images in the form of electronic watermarks and printed on the tickets or cards so as not to be visually detectable. When the tickets or cards are used, the electronic watermarks can be detected to avoid counterfeiting, unauthorized acquisition, and other frauds. Besides, unauthorized duplication of copyrighted materials, securities, and the like can be precluded by embedding copyright information, device identification information, and the like as electronic watermarks when printing images with copy machines or printers.

In general, when printed images are captured and digitized by a digital camera or a scanner, lens distortion and perspective distortion occur in the captured images. Here, the lens distortion depends on the shape and focal length of the lens of the capturing device, and the perspective distortion is ascribable to a tilt of the optical axis at the time of capturing. As a result, the printed images and the captured images cause pixel deviation therebetween. This makes it difficult for electronic watermarks embedded in the printed images to be extracted from the captured images properly, and thus requires distortion correction on the captured images.

The patent document 1 discloses an image correction apparatus which performs the following processing: generating a mapping function pertaining to perspective distortion based on position deviations of feature points of a calibration pattern near a screen center; evaluating differences between ideal positions of the feature points and actual positions of the same on an image across the entire screen by using the mapping function; calculating a correction function for correcting lens distortion; and correcting image data.

Moreover, there are systems in which information embedded as electronic watermarks is extracted from digital image data transmitted from clients, and services (such as contents download services and product sales services) are provided to the clients based on the extracted information (for example, see patent document 2).

FIG. 59 is a block diagram of a product sales system 1200, an example of such a system. The product sales system 1200 comprises a server 1201, a camera with communication facilities (camera-equipped cellular phone 1202), and a catalog (a printed material 1203). Various illustrations showing products are printed on the printed material 1203. These illustrations and the sales products correspond on a one-to-one basis. In each illustration, identification information on the product (such as product ID) is invisibly embedded in the form of an electronic watermark.

In such a product sales system 1200, when a client captures an illustration on the printed material 1203 with his/her camera-equipped cellular phone 1202, the data on the captured image generated by the camera-equipped cellular phone 1202 is transmitted to the server 1201. The server 1201 extracts the information embedded as an electronic watermark from data on the captured image, and determines from the extracted result the product the client wants to purchase. [Patent document 1] Japanese Patent Publication No. 2940736 [Patent document 2] Japanese Publication of PCT International Application No. 2002-544637

To correct image distortion ascribable to capturing, it is necessary to acquire information on the distortion characteristics of the capturing device and information on the tilt of the optical axis at the time of capturing, and apply geometric transform to the captured image. Fine distortion correction can be made by using profile data that shows the detailed distortion characteristics of the lens, whereas the profile data requires a large storage capacity and takes long to process.

In addition, how finely image distortion must be examined and corrected depends on the tolerance of watermarks to image distortion. When the watermarks have relatively high tolerance to image distortion, fine distortion correction is wasteful. With low tolerance to image distortion, on the other hand, the watermarks cannot be detected properly by rough distortion correction. A mismatch between the tolerance of watermarks when embedded and the precisions of image correction when extracting the watermarks can thus deteriorate the detection accuracy and the detection efficiency of the watermarks.

Moreover, when selling products of the same model but different colors in the foregoing product sales system 1200, the printed material 1203 must carry illustrations of the products of the same model as many as the number of color variations. This produces a problem of increased space of the printed material 1203.

The print space can be reduced by preparing product images separately from images in which only color information is embedded (for example, for eight color variations, eight images are prepared separately). For example, when purchasing a product in red, two images, i.e., the illustration of the product and an image for representing red are captured in succession. The number of images required here is only the number of products plus the number of types of color information, being smaller than with the method where color information is given to each individual product (the number of images required is the number of products multiplied by the number of colors). The print space thus decreases significantly. In this case, however, the server 1201 is put under high load since it must process both the product images and the color information images.

Then, instead of printing illustrations corresponding to the number of color variations on the printed material 1203, illustrations corresponding to the products alone may be printed on the printed material 1203 so that the client presses accompanying buttons on the capturing device to select desired product colors.

More specifically, the client initially captures the illustration of a desired product with the camera-equipped cellular phone 1202. Next, the client presses an accompanying button on the camera-equipped cellular phone 1202 to select the desired color of the product. The data on the captured image and the information selected by button depression are then transmitted from the camera-equipped cellular phone 1202 to the server 1201.

Such a method, however, requires that the client make a burdensome selecting operation by button depression after the capturing operation.

### DISCLOSURE OF THE INVENTION

The present invention has been achieved in view of the foregoing. It is thus an object of the present invention to provide an image correction technology capable of correcting image distortion efficiently with high precision. Another object of the present invention is to provide an information processing technology of high convenience, using electronic watermarks.

To solve the foregoing problems, an image correction apparatus according to one of the aspects of the present invention comprises: a lens distortion calculation unit which calculates lens distortion correction information with respect to each zoom magnification, based on known images captured at respective different zoom magnifications; and a memory unit which stores the lens distortion correction information in association with the zoom magnifications.

As employed herein, “storing the lens distortion correction information in association with the zoom magnifications” shall not only refer to the cases where the lens distortion correction information is stored in association with the zoom magnifications themselves, but also cover the cases where it is stored substantially in association with the zoom magnifications. For example, given that the CCD (Charge-Coupled Device) surface or film surface for subject images to be formed on has a constant longitudinal length, the angle of view and the focal length both vary in accordance with the zoom magnification. Thus, the expression “storing . . . in association with the zoom magnifications” shall also cover the cases where the lens distortion correction information is stored in association with the angles of view or focal lengths.

Another aspect of the present invention also provides an image correction apparatus. This apparatus comprises: a memory unit which contains lens distortion correction information in association with zoom magnifications of a lens; a selector unit which selects lens distortion correction information corresponding to a zoom magnification employed at the time of capturing of an input captured image from the memory unit; and a distortion correction unit which corrects distortion of the captured image ascribable to capturing based on the lens distortion correction information selected.

The selector unit may select from the memory unit a plurality of candidate pieces of lens distortion correction information in accordance with the zoom magnification employed at the time of capturing, and correct a row of sample points forming a known shape in the captured image by using each of the plurality of pieces of lens distortion correction information for error pre-evaluation. Thereby, the selector unit may select one piece of lens distortion correction information from among the plurality of pieces of lens distortion correction information.

As employed herein, “a row of sample points forming a known shape” refers to the cases where the shape the row of sample points are supposed to form if without any capturing distortion is known. For example, a row of sample points assumed on the image frame of a captured image are known to fall on a straight line if there is no capturing distortion. In another example, a row of sample points assumed on the outline of a person's face captured are known to fall at least on a smooth curve.

Yet another aspect of the present invention also provides an image correction apparatus. This apparatus comprises: a lens distortion calculation unit which calculates based on known images captured at respective different zoom magnifications a lens distortion correction function for mapping points in a lens-distorted image onto points in an image having no lens distortion and a lens distortion function, or an approximate inverse function of the lens distortion correction function, with respect to each lens magnification; and a memory unit which stores the pairs of lens distortion correction functions and lens distortion functions in association with the zoom magnifications.

As employed herein, “storing the pairs of lens distortion correction functions and lens distortion functions in association with the zoom magnifications” is not limited to the cases of storing such information as functional expressions and coefficients. It also covers the cases where the correspondence between input values and output values of these functions are stored in the form of a table. For example, the correspondence between coordinate values in an image and coordinate values mapped by these functions may be stored as a table.

Yet another aspect of the present invention also provides an image correction apparatus. This apparatus comprises: a memory unit which contains pairs of lens distortion correction functions for mapping points in a lens-distorted image onto points in an image having no lens distortion and lens distortion functions, or approximate inverse functions of the lens distortion correction functions, in association with respective zoom magnifications of a lens; a selector unit which selects the lens distortion function corresponding to a zoom magnification employed at the time of capturing of an input captured image from the memory unit; and a distortion correction unit which corrects distortion of the captured image ascribable to capturing based on the lens distortion function selected. According to this configuration, it is possible to correct lens distortion ascribable to capturing.

Yet another aspect of the present invention also provides an image correction apparatus. This apparatus comprises: a memory unit which contains lens distortion functions for mapping points in an image having no lens distortion onto points in a lens-distorted image in association with respective zoom magnifications of a lens; a selector unit which selects the lens distortion function corresponding to a zoom magnification employed at the time of capturing of an input captured image from the memory unit; a perspective distortion calculation unit which calculates a perspective distortion function for mapping points in an image having no perspective distortion onto points in a perspective-distorted image, by using an image whose lens distortion is corrected by the lens distortion function selected; and a distortion correction unit which corrects distortion of the captured image ascribable to capturing based on the perspective distortion function calculated by the perspective distortion calculation unit. According to this configuration, it is possible to correct perspective distortion and lens distortion ascribable to capturing.

Yet another aspect of the present invention provides an image correction database creating method. This method comprises: calculating based on known images captured at respective different zoom magnifications a lens distortion correction function for mapping points in a lens-distorted image onto points in an image having no lens distortion and a lens distortion function, or an approximate inverse function of the lens distortion correction function, with respect to each lens magnification; and registering the pairs of lens distortion correction functions and lens distortion functions into a database in association with the zoom magnifications.

Yet another aspect of the present invention provides an image correction method. This method comprises: consulting a database in which pairs of lens distortion correction functions for mapping points in a lens-distorted image onto points in an image having no lens distortion and lens distortion functions, or approximate inverse functions of the lens distortion correction functions, are registered in association with respective zoom magnifications of a lens, and selecting the lens distortion function corresponding to a zoom magnification employed at the time of capturing of an input captured image; and correcting distortion of the captured image ascribable to capturing based on the lens distortion function selected.

Yet another aspect of the present invention also provides an image correction method. This method comprises: consulting a database in which lens distortion functions for mapping points in an image having no lens distortion onto points in a lens-distorted image are registered in association with respective zoom magnifications of a lens, and selecting the lens distortion function corresponding to a zoom magnification employed at the time of capturing of an input captured image; calculating a perspective distortion function for mapping points in an image having no perspective distortion onto points in a perspective-distorted image, by using an image whose lens distortion is corrected by the lens distortion function selected; and correcting distortion of the captured image ascribable to capturing based on the perspective distortion function calculated.

An information provision apparatus according to yet another aspect of the present invention comprises: an electronic watermark extraction unit which extracts information embedded by electronic watermark technology from imaging data obtained by an imaging device; a distortion detection unit which detects image distortion from the imaging data; an information data storing unit which stores information data; a selector unit which selects information data stored in the information data storing unit based on the information embedded by the electronic watermark technology, extracted by the electronic watermark extraction unit, and the image distortion detected by the distortion detection unit; and an output unit which outputs the information data selected by the selector unit to exterior.

The foregoing information data refers to text data, image data, moving image data, voice data, etc.

An information provision apparatus according to yet another aspect of the present invention comprises: an electronic watermark extraction unit which extracts information embedded by electronic watermark technology from imaging data obtained by an imaging device; a distortion detection unit which detects image distortion from the imaging data; an information data storing unit which stores information data; a selector unit which selects information data stored in the information data storing unit based on the information embedded by the electronic watermark technology, extracted by the electronic watermark extraction unit, and the image distortion detected by the distortion detection unit; and a display unit which displays contents of the information data selected by the selector unit.

An image processing apparatus according to yet another aspect of the present invention comprises: an electronic watermark extraction unit which extracts information embedded by electronic watermark technology from imaging data obtained by an imaging device; a distortion detection unit which detects image distortion from the imaging data; an image data storing unit which stores image data; and a selector unit which selects image data stored in the image data storing unit based on the information embedded by the electronic watermark technology, extracted by the electronic watermark extraction unit, and the image distortion detected by the distortion detection unit.

An image processing apparatus according to yet another aspect of the present invention comprises: a distortion detection unit which detects image distortion from imaging data obtained by an imaging device; a distortion correction unit which corrects the image distortion of the imaging data based on the image distortion detected by the distortion detection unit; an electronic watermark extraction unit which extracts information embedded by electronic watermark technology from the imaging data whose image distortion is corrected by the distortion correction unit; an image data storing unit which stores image data; and a selector unit which selects image data stored in the image data storing unit based on the information embedded by the electronic watermark technology, extracted by the electronic watermark extraction unit, and the image distortion detected by the distortion detection unit.

An information terminal according to yet another aspect of the present invention comprises: an imaging unit; a distortion detection unit which detects image distortion from imaging data obtained by the imaging unit; a distortion correction unit which corrects the image distortion of the imaging data based on the image distortion detected by the distortion detection unit; and a transmission unit which transmits the imaging data whose image distortion is corrected by the distortion correction unit and information on the image distortion detected by the distortion detection unit to exterior.

An image processing apparatus according to yet another aspect of the present invention comprises: a reception unit which receives imaging data and information on image distortion transmitted from an information terminal; an electronic watermark extraction unit which extracts information embedded by electronic watermark technology from the imaging data; an information data storing unit which stores information data; and a selector unit which selects information data stored in the information data storing unit based on the information embedded by the electronic watermark technology, extracted by the electronic watermark extraction unit, and the information on the image distortion received by the reception unit.

An information terminal according to yet another aspect of the present invention comprises: an imaging unit; a distortion detection unit which detects image distortion from imaging data obtained by the imaging unit; a distortion correction unit which corrects the image distortion of the imaging data based on the image distortion detected by the distortion detection unit; an electronic watermark extraction unit which extracts information embedded by electronic watermark technology from the imaging data whose image distortion is corrected by the distortion correction unit; and a transmission unit which transmits the information embedded by the electronic watermark technology, extracted by the electronic watermark extraction unit, and information on the image distortion detected by the distortion detection unit to exterior.

An information database apparatus according to yet another aspect of the present invention comprises: a distortion detection unit which detects image distortion from imaging data obtained by an imaging device; an information data storing unit which stores information data; and a selector unit which selects information data stored in the information data storing unit based on the image distortion detected by the distortion detection unit.

A data structure according to yet another aspect of the present invention is one to be transmitted from an information terminal having an imaging unit, the data structure containing information on image distortion detected from imaging data obtained by the imaging unit.

It should be appreciated that any combinations of the foregoing components, and any conversions of expressions of the present invention from/into methods, apparatuses, systems, recording media, computer programs, and the like are also intended to constitute applicable aspects of the present invention.

### BRIEF DESCRIPTION OF THE DRAWINGS

FIG. 1 is a block diagram of an electronic watermark embedding apparatus according to a first embodiment;

FIGS. 2A to 2D are diagrams for explaining a block embedding method of the block embedding unit of FIG. 1;

FIG. 3 is a diagram for explaining a printed image output from the electronic watermark embedding apparatus of FIG. 1;

FIG. 4 is a block diagram of an electronic watermark extracting apparatus according to the first embodiment;

FIG. 5 is a diagram for explaining a printed image captured by the electronic watermark extracting apparatus of FIG. 4;

FIG. 6 is a diagram for explaining a pixel deviation due to capturing;

FIG. 7 is a diagram for explaining the detailed configuration of the profile creation unit and the image correction unit of FIG. 4;

FIGS. 8A and 8B are diagrams for explaining the relationship between the angle of view and the focal length of a zoom lens;

FIGS. 9A and 9B are diagrams for explaining lens distortion function pairs to be stored in the profile database of FIG. 7;

FIG. 10 is a flowchart for explaining the steps by which the electronic watermark extracting apparatus creates a profile database;

FIG. 11 is a diagram for explaining a lattice pattern image to be used as a calibration pattern;

FIG. 12 is a diagram for explaining a lens distortion function pair;

FIG. 13 is a flowchart showing an overall flow of the steps for extracting an electronic watermark according to the first embodiment;

FIG. 14 is a flowchart for showing a general flow of the image correction processing of FIG. 13;

FIG. 15 is a flowchart showing the detailed steps for selecting a lens distortion function pair in FIG. 14;

FIG. 16 is a flowchart showing the detailed steps of the image correction main processing of FIG. 14;

FIG. 17 is a diagram for explaining how a point in a correction target image is mapped onto a point in a correction object image;

FIG. 18 is a diagram for explaining the method of calculating the luminance value at a point mapped by a lens distortion function;

FIG. 19 is a flowchart showing the detailed steps of the image area determination processing of FIG. 13;

FIG. 20 is a diagram for explaining how feature points are extracted from a lens-distortion-corrected image;

FIG. 21 is a flowchart for showing the detailed steps for selecting a lens distortion function pair, where a method of selection for a speed-priority system and a method of selection for a precision-priority system can be switched;

FIG. 22 is a flowchart showing the detailed steps for the pre-evaluation of correction functions of FIG. 21;

FIGS. 23A to 23C are diagrams for explaining how approximation errors of a Bezier curve are evaluated;

FIG. 24 is a flowchart showing the detailed steps for acquiring a row of sample points between feature points in FIG. 22;

FIG. 25A is a diagram for explaining how edge detection processing is performed on an original image area, and FIG. 25B is a diagram for explaining spline approximation on each side of the original image area;

FIG. 26 is a block diagram showing the electronic watermark extracting apparatus according to a second embodiment;

FIG. 27 is a diagram for explaining the detailed configuration of the profile creation unit and the image correction unit of FIG. 26;

FIG. 28 is a flowchart showing an overall flow of the electronic watermark extracting steps according to the second embodiment;

FIG. 29 is a flowchart for showing a general flow of the image correction processing of FIG. 28;

FIG. 30 is a flowchart showing the detailed steps for the calculation of a perspective distortion function of FIG. 29;

FIG. 31 is a flowchart showing the detailed steps of the image correction main processing of FIG. 29;

FIGS. 32A to 32C are diagrams for explaining how a point in a correction target image is mapped onto a point in a correction object image;

FIG. 33 is a block diagram of an image data provision system according to a third embodiment;

FIG. 34 is a conceptual rendering of a watermarked product image;

FIGS. 35A to 35C are diagrams showing directions in which a client captures the watermarked product image in the third embodiment;

FIG. 36 is an image of a digital camera, or an example of the product, as viewed from the front;

FIG. 37 is an image of the digital camera, or an example of the product, as viewed from behind;

FIG. 38 is a block diagram of a camera-equipped cellular phone according to the third embodiment;

FIG. 39 is a block diagram of a server according to the third embodiment;

FIG. 40 is a captured image when the watermarked product image is captured from directly above (“+z” side of FIG. 34);

FIG. 41 is a captured image when the watermarked product image is captured from top left (“+z, −x” side of FIG. 34);

FIG. 42 is a captured image when the watermarked product image is captured from top right (“+z, +x” side of FIG. 34);

FIG. 43 is a diagram showing the contents of the image data indexing unit of the server according to the third embodiment;

FIG. 44 is a flowchart showing the processing of the server 1001 according to the third embodiment;

FIGS. 45A and 45B are diagrams showing captured images according to a modification of the third embodiment;

FIG. 46 is a diagram for explaining ζ-axis and η-axis with reference to the watermarked product image according to the third embodiment;

FIG. 47 is a block diagram of a camera-equipped cellular phone according to a fourth embodiment;

FIG. 48 is a block diagram of a server according to the fourth embodiment;

FIG. 49 is a flowchart showing the processing of the camera-equipped cellular phone according to the fourth embodiment;

FIG. 50 is a flowchart showing the processing of the server according to the fourth embodiment;

FIG. 51 is a block diagram of a product purchase system according to a fifth embodiment;

FIG. 52 is a diagram showing a watermarked product image according to the fifth embodiment;

FIG. 53 is a block diagram of a server in the product purchase system according to the fifth embodiment;

FIG. 54 is a diagram showing the contents of the product database of the server according to the fifth embodiment;

FIG. 55 is a conceptual diagram of the product purchase system according to the fifth embodiment;

FIGS. 56A and 56B are conceptual diagrams of the product purchase system according to a modification of the fifth embodiment;

FIG. 57 is a diagram showing the configuration of a quiz answering system according to a sixth embodiment;

FIGS. 58A and 58B are diagrams showing directions in which a client captures the watermarked product image according to the sixth embodiment; and

FIG. 59 is a block diagram of a product sales system which uses electronic watermarks.

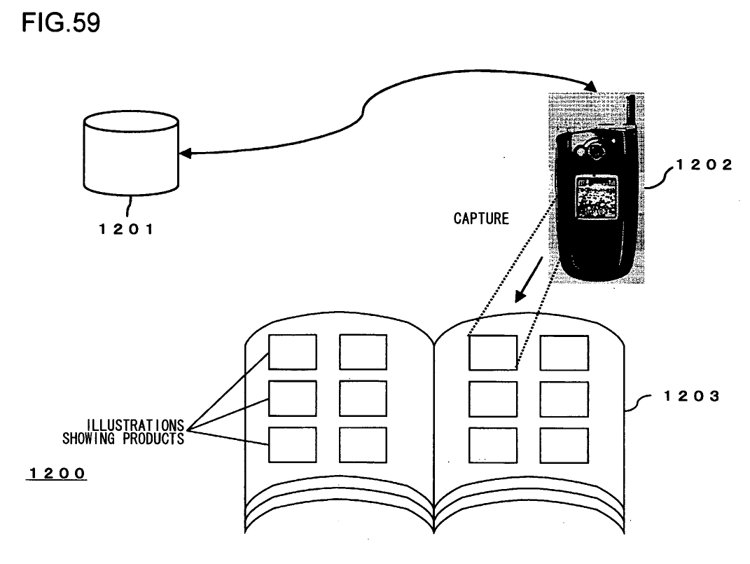

### BEST MODE FOR CARRYING OUT THE INVENTION

### First Embodiment

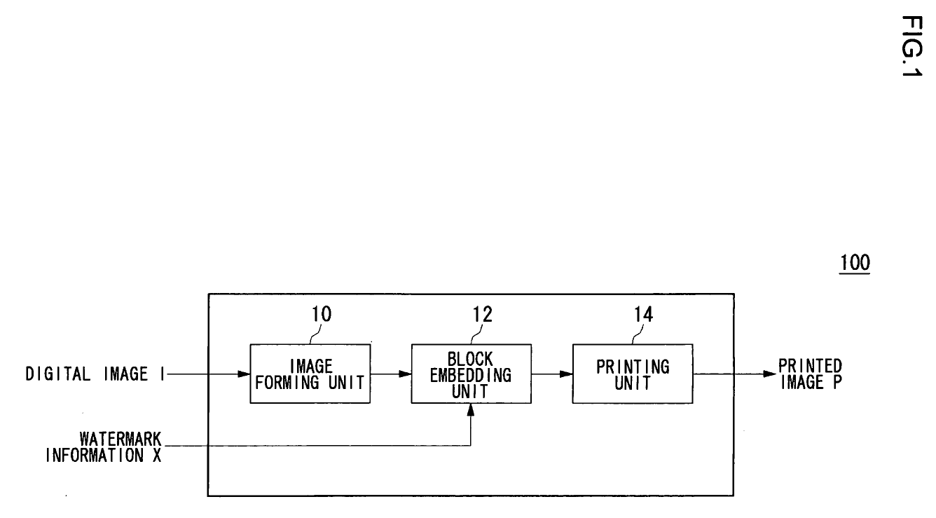

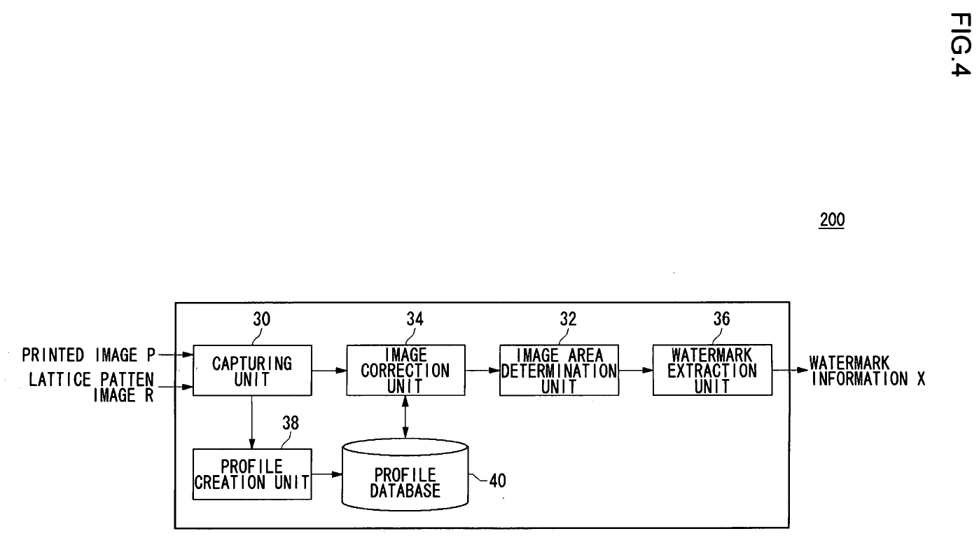

An electronic watermark system according to a first embodiment of the present invention includes an electronic watermark embedding apparatus 100 as shown in FIG. 1 and an electronic watermark extracting apparatus 200 as shown in FIG. 4. The electronic watermark embedding apparatus 100 generates printed images having electronic watermarks embedded therein. The electronic watermark extracting apparatus 200 captures the printed images and extracts the embedded electronic watermarks. For example, the electronic watermark embedding apparatus 100 is used to issue tickets and cards, and the electronic watermark extracting apparatus 200 is used to detect counterfeit tickets and cards. Both the apparatuses may be configured as a server to be accessed from network terminals.

FIG. 1 is a block diagram of the electronic watermark embedding apparatus 100 according to the first embodiment. In terms of hardware, these components can be achieved by an arbitrary computer CPU, a memory, and other LSIs. In terms of software, they can be achieved by programs or the like that are loaded on a memory and have the functions for processing images and embedding electronic watermarks. The functional blocks shown here are achieved by the cooperation of these. It will thus be understood by those skilled in the art that these functional blocks may be achieved in various forms including hardware alone, software alone, and a combination of these.

An image forming unit 10 converts an input digital image I into a printing resolution of W pixels in the horizontal direction (also referred to as x-axis direction) and H pixels in the vertical direction (also referred to as y-axis direction). For example, the image sizes W=640 and H=480.

A block embedding unit 12 embeds watermark information X into the digital image I having the printing resolution, converted by the image forming unit 10. Here, the block embedding unit 12 divides the digital image I into square blocks of predetermined size, and embeds identical watermark bits into some blocks redundantly. This method of embedding the watermark information X into the digital image I is referred to as “block embedding method.” The blocks of the digital image I where the watermark bits are embedded are referred to as “embedded blocks.” For example, the block size N is four.

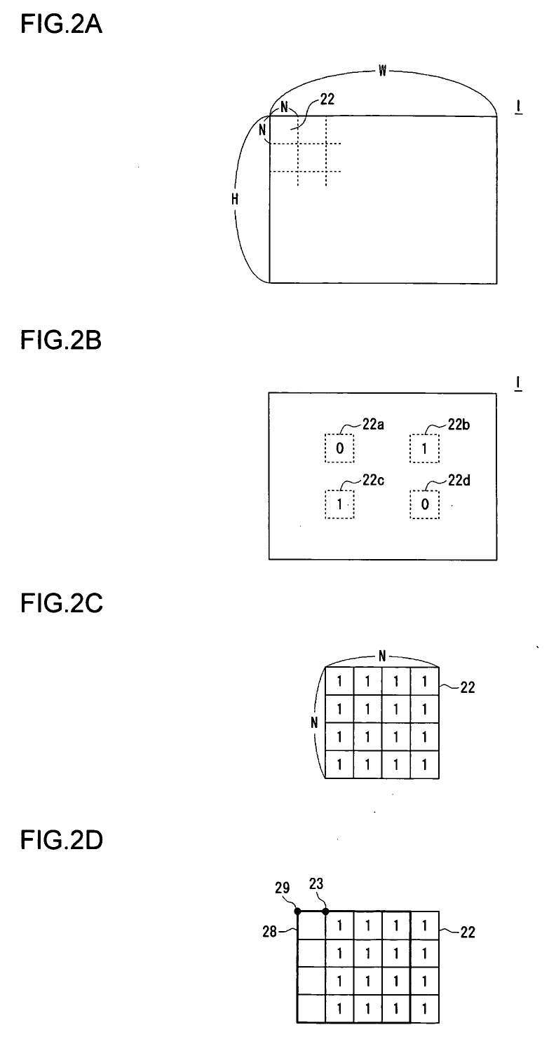

FIGS. 2A to 2D are diagrams for explaining the block embedding method of the block embedding unit 12. FIG. 2A is a diagram for explaining how the digital image I is divided into blocks. The digital image I having a matrix of W×H pixels is divided into embedded blocks 22 of N×N pixels.

The block embedding unit 12 selects embedded blocks 22 of the digital image I for respective watermark bits constituting the watermark information X to be embedded into. The block embedding unit 12 embeds identical watermark bits into the respective embedded blocks 22 redundantly. FIG. 2B is a diagram for explaining the digital image I in which watermark bits are embedded. The diagram will deal with an example where the watermark information X consists of a watermark bit string (0, 1, 1, 0). From the digital image I, the block embedding unit 12 selects an embedded block 22a intended for the first watermark bit “0” to be embedded into, an embedded block 22b for the second watermark bit “1” to be embedded into, an embedded block 22c for the third watermark bit “1” to be embedded into, and an embedded block 22d for the fourth watermark bit “0” to be embedded into. The block embedding unit 12 then embeds the watermark bits into the respective blocks 22a to 22d redundantly.

FIG. 2C is a diagram for explaining watermark bits embedded in an embedded block 22. Here, description will be given of an example where the block size N is four and the watermark bits are “1.” As shown in the diagram, 16 watermark bits “1” are embedded into the embedded block 22 redundantly.

FIG. 2D is a diagram for explaining a pixel deviation to occur while extracting the watermark bits, and its influence on the detection of the watermark bits. Suppose that an embedded block 28 detected from a captured image has an actual endpoint 29 that is horizontally one pixel off an ideal endpoint 23 of the embedded block 22 in the original image as shown in the diagram. Even in this case, 12 identical watermark bits “1” are detected redundantly from the area where the embedded block 22 of the original image and the embedded block 28 of the captured image overlap with each other. As a result, it is possible to detect the correct watermark bit by a majority vote within the block. The block embedding method can thus improve the tolerance for pixel deviations.

A printing unit 14 prints the digital image I having the watermark information X embedded by the block embedding unit 12 onto a printing medium, thereby generating a printed image P. It should be noted that while the diagram shows the printing unit 14 as being one of the components of the electronic watermark embedding apparatus 100, the printing unit 14 may be configured as a printer which lies outside the electronic watermark embedding apparatus 100. In that case, the electronic watermark embedding apparatus 100 and the printer are connected with a peripheral connection cable or over a network.

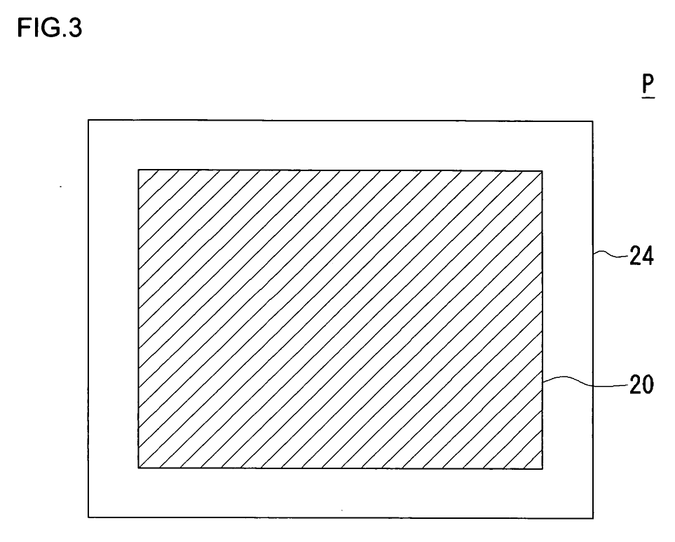

FIG. 3 is a diagram for explaining the output printed image P. The digital image I having an electronic watermark embedded therein (also referred to as original image) is printed on a printing medium 24. The area 20 where the original image is printed on (hereinafter, referred to simply as original image area 20) is typically surrounded by margins of the printing medium 24.

FIG. 4 is a block diagram showing the electronic watermark extracting apparatus 200 according to the first embodiment. A capturing unit 30 captures printed images P having electronic watermarks embedded therein or lattice pattern images R, thereby converting the same into an electronic form. A profile creation unit 38 detects position deviations of lattice points in the lattice pattern images R captured at different zoom magnifications, and generates correction information on distortion occurring in the images. The correction information is stored into a profile database 40 in association with the zoom magnifications. An image correction unit 34 selects correction information corresponding to a zoom magnification employed at the time of capturing a printed image P from the profile database 40, and corrects distortion occurring in the captured image of the printed image P. An image area determination unit 32 determines the original image area 20 in the distortion-corrected captured image. A watermark extraction unit 36 divides the original image area 20 in the distortion-corrected captured image into blocks, and detects watermark bits embedded in the respective blocks to extract watermark information X. These components can also be achieved in various forms, including any combinations of hardware such as a CPU and a memory and pieces of software having the functions for processing images and extracting electronic watermarks.

The profile creation unit 38, the image correction unit 34, and the profile database 40 of the electronic watermark extracting apparatus 200 constitute an example of the image correction apparatus according to the present invention.

The capturing unit 30 captures printed images P generated by the electronic watermark embedding apparatus 100, and digitizes the printed images P. While the diagram shows the capturing unit 30 as being one of the components of the electronic watermark extracting apparatus 200, the capturing unit 30 may be configured as a digital camera or scanner which lies outside the electronic watermark extracting apparatus 200. In that case, the electronic watermark extracting apparatus 200 and the digital camera or scanner are connected with a peripheral connection cable or over a network. When the digital camera has wireless communication facilities in particular, images captured by the digital camera are transmitted to the electronic watermark extracting apparatus 200 by wireless.

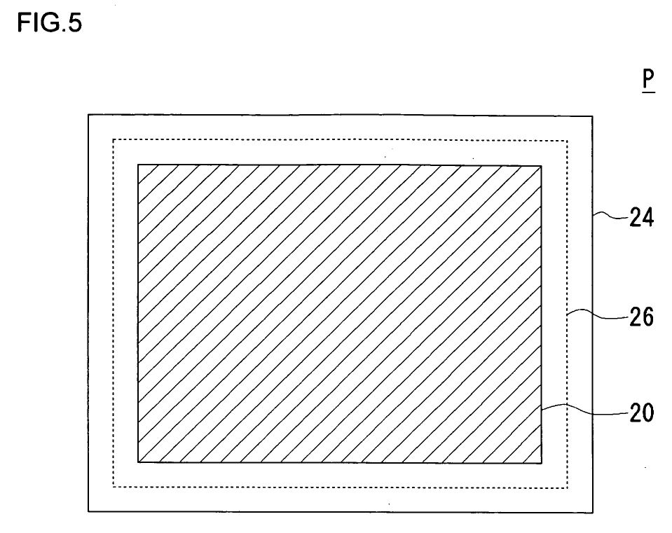

FIG. 5 is a diagram for explaining a printed image P captured. When the capturing unit 30 captures the printed image P, it captures the entire original image area 20 of the printing medium 24, typically with the margins around the original image area 20. That is, the captured area 26 is typically wider than the original image area 20 on the printing medium 24. Since the image captured by the capturing unit 30 thus includes margins on the printing medium 24, the original image area 20 must be cut out after the distortion of the captured image is corrected.

The image correction unit 34 performs a distortion correction on the entire captured image. When the printed image P is captured by the capturing unit 30, a lens distortion and a perspective distortion can occur in the captured image. The image correction unit 34 corrects the distortions occurring in the image so that the embedded electronic watermark can be extracted properly. The distortion correction uses functions intended for correcting distortion, which are stored in the profile database 40.

The image area determination unit 32 applies edge extraction and other processing to the captured image whose distortion is corrected by the image correction unit 34, and determines the area of the original image. This cuts out the original image area 20, removing the margins from the captured area 26 of FIG. 5.

The watermark extraction unit 36 divides the original image area 20 determined by the image area determination unit 32 into blocks of N×N pixels, and detects watermark bits from respective blocks to extract the watermark information X. When detecting the watermark bits embedded by the block embedding method, distortion of the embedded blocks, if any, can make the watermark detection difficult. Since the distortion is corrected by the image correction unit 34, however, the accuracy of the watermark detection is guaranteed. Moreover, even if some pixel deviation remains after the distortion correction, it is possible to detect correct watermark bits since the watermark bits are embedded redundantly in the respective blocks.

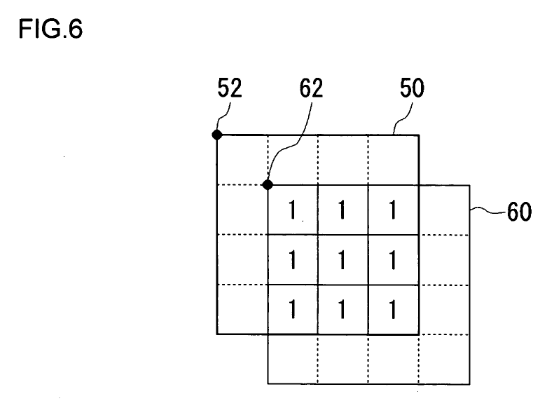

FIG. 6 is a diagram for explaining a pixel deviation due to capturing. Suppose that an embedded block 60 of the captured image does not match with the embedded block 50 of the original image as shown in the diagram. With respect to an endpoint 52 of the embedded block 50 in the original image, the endpoint 62 of the embedded block 60 in the captured image is one pixel off in both horizontal and vertical directions. Even in such situations, identical watermark bits (here, shown by “1”) are detected redundantly from the area where the embedded block 50 of the original image and the embedded block 60 of the captured image overlap with each other. The watermark extraction unit 36 can thus detect the proper watermark bit.

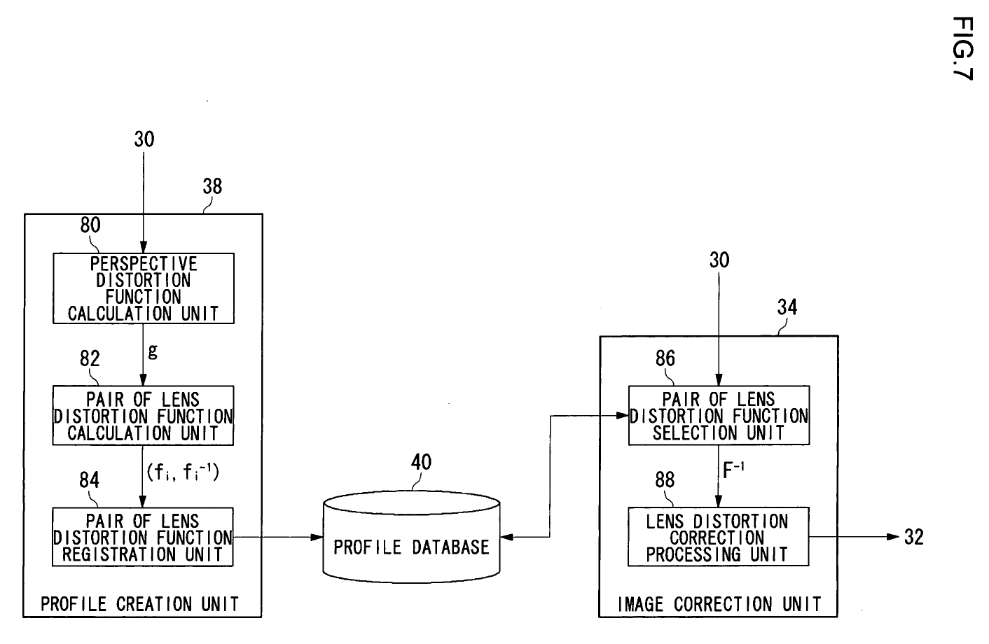

FIG. 7 is a diagram for explaining the detailed configuration of the profile creation unit 38 and the image correction unit 34. The profile creation unit 38 includes a perspective distortion function calculation unit 80, a lens distortion function pair calculation unit 82, and a lens distortion function pair registration unit 84. The image correction unit 34 includes a lens distortion function pair selection unit 86 and a lens distortion correction processing unit 88.

Initially, description will be given of how correction information is registered into the profile database 40. To measure lens distortion, the capturing unit 30 captures the lattice pattern image R, and supplies it to the profile creation unit 38. When a zoom lens is used for capturing, the zoom magnification is changed to capture the lattice pattern image R with a plurality of angles of view θᵢ. The perspective distortion function calculation unit 80 of the profile creation unit 38 accepts input of the image area of the lattice pattern image R, and detects position deviations of the intersections in the pattern of the lattice pattern image R ascribable to perspective distortion. The perspective distortion function calculation unit 80 thereby calculates a perspective distortion function g for mapping points in an image having no perspective distortion onto points in a perspective-distorted image.

The lens distortion function pair calculation unit 82 accepts input of the perspective distortion function g calculated by the perspective distortion function calculation unit 80, and detects position deviations of the intersections in the pattern of the lattice pattern image R in consideration of the perspective distortion. The lens distortion function pair calculation unit 82 thereby calculates a lens distortion correction function fᵢ and a lens distortion function fᵢ⁻¹ at an angle of view θᵢ. Here, the lens distortion correction function fᵢ is one for mapping points in a lens-distorted image onto points in an image having no lens distortion. The lens distortion function fᵢ⁻¹ is an approximate inverse function of the lens distortion correction function fᵢ, and maps points in an image having no lens distortion onto points in a lens-distorted image. The pair of the lens distortion correction function fᵢ and the lens distortion function fᵢ⁻¹ will be referred to as a lens distortion function pair (fᵢ, fᵢ⁻¹).

The lens distortion function pair registration unit 84 registers the lens distortion function pair (fᵢ, fᵢ⁻¹) calculated by the lens distortion function pair calculation unit 82 into the profile database 40 in association with the angle of view θᵢ.

Next, description will be given of the image correction using the foregoing profile database 40. The capturing unit 30 supplies a captured printed image P to the image correction unit 34. The lens distortion function pair selection unit 86 of the image correction unit 34 accepts the input of the captured image of the printed image P, and determines the angle of view θ employed at the time of capturing from image information. The lens distortion function pair selection unit 86 then selects a lens distortion function pair (F, F⁻¹) corresponding to the angle of view θ employed at the time of capturing from the profile database 40, and supplies the lens distortion function F⁻¹ to the lens distortion correction processing unit 88. The lens distortion correction processing unit 88 corrects the lens distortion of the entire captured image by using the lens distortion function F⁻¹, and supplies the corrected captured image to the image area determination unit 32.

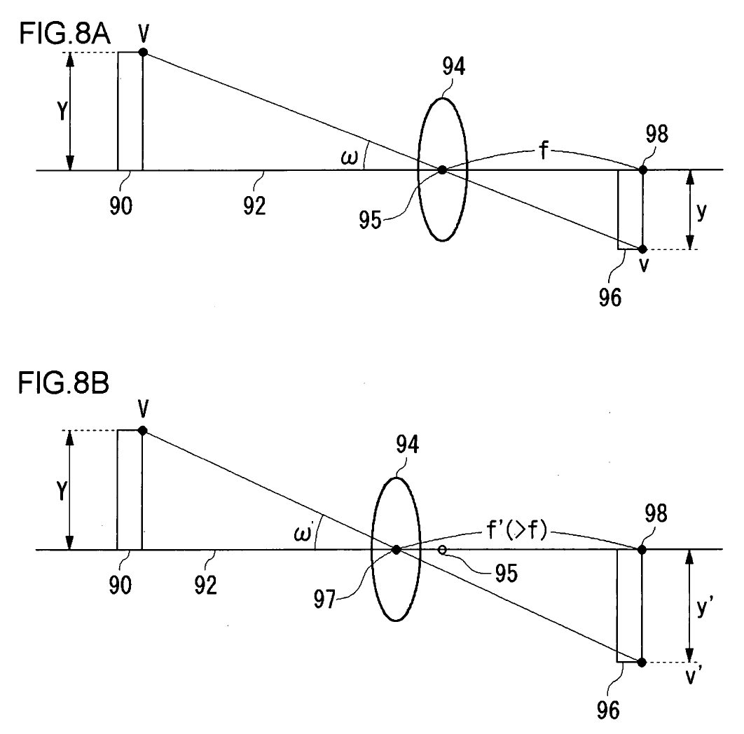

FIGS. 8A and 8B are diagrams for explaining the relationship between the angle of view and the focal length of a zoom lens. FIG. 8A shows the state where a lens 94 is focused on a subject 90. The vertex V of the subject 90 corresponds to the vertex v of the subject image on the imaging area of a CCD 96. Here, the principle point 95 lies at the center of the lens 94, and the focal length f is the distance between the principle point 95 and a single point (referred to as focus) into which parallel light incident in the normal direction of the lens converges. The optical axis 92 is a straight line that passes the principle point 95 and has a gradient in the normal direction of the lens 94. The angle ω formed between the optical axis 92 and a straight line that connects the principle point and the vertex V of the subject 90 is called a half angle of view, and twice ω is called the angle of view. As employed herein, the half angle of view ω will be referred to simply as “the angle of view.”

The height of the subject 90 to be focused will be referred to as Y, and the height of the subject image on the imaging area of the CCD 96 as y. The magnification m is the ratio of the height y of the subject image formed on the CCD 96 with respect to the actual height Y of the subject 90, and is given by m=y/Y. Here, a perfect in-focus state will be defined as follows:

Definition 1: A Subject is in Perfect Focus

That a subject is in perfect focus refers to situations where the straight line that connects the vertex of the subject and the vertex of the subject image formed on the CCD surface passes the principle point, and the distance from the principle point to the CCD surface in the normal direction of the lens is equal to the focal length.

Under the perfect in-focus state in terms of definition 1, the point at which the optical axis 92 and the imaging area of the CCD 96 cross each other will be referred to as a focus center 98.

Lenses are broadly classified into two types, or single-focus lenses and zoom lenses. Single-focus lenses are incapable of changing their focal length f. In contrast, zoom lenses are composed of a combination of two or more lenses each, and can change the focal length f, the principle point, and the like freely by adjusting the distances between the lenses and the distances from the respective lenses to the imaging area of the CCD 96. Description will now be given of how to change the magnification of a subject by using a zoom lens. Initially, a change in magnification will be defined as follows:

Definition 2: A Change in Magnification

A change in magnification shall refer to changing the height of the subject image formed on the CCD surface without changing the distance between the subject plane and the CCD surface, while maintaining the perfect in-focus state.

What are significant are “without changing the distance between the subject plane and the CCD surface” and “while maintaining the perfect in-focus state.” For example, a person who holds a camera can move away from a subject to make the image formed on the CCD surface smaller, whereas this does not apply to a change in magnification since the distance between the subject plane and the CCD surface varies.

FIG. 8B shows an example where the focal length of the lens 94 is changed from f to f′ with a change in magnification by definitions 1 and 2. Changing the focal length moves the principle point 97 of the lens 94. The straight line that connects the vertex V of the subject 90 and the vertex v′ of the subject image formed on the imaging area of the CCD 97 passes the principle point 97 of the lens 94 after the focal length is changed. The distance between the subject 90 and the CCD 96 is the same as in FIG. 8A, i.e., is in perfect focus in terms of definition 1.

Here, the height of the subject image formed on the imaging area of the CCD 96 varies from y to y′ (>y), so that the magnification is changed into m=y′/Y. The angle of view is also changed from ω to ω′ (>ω). It should be noted that in actual cameras, a zoom lens is composed of a combination of two or more lenses. The distances between the lenses and the distances from the respective lenses to the CCD surface are adjusted to adjust the focal length and the position of the principle point, thereby changing the magnification.

It is known that lens distortion or distortion aberration to be corrected depends on the angle of view ω. This property is described in “KOGAKU NYUMON (User Engineer's Guide to Optics)” KISHIKAWA Toshio, Optronics Books, 1990. For a single-focus lens which is incapable of changing its focal length and thus makes no change in the angle of view, it is only necessary that a single lens distortion function pair be prepared and registered in the profile database 40. With a zoom lens, on the other hand, it is necessary to determine lens distortion function pairs (fᵢ, fᵢ⁻¹) at various angles of view θᵢ by changing the magnification while maintaining the perfect in-focus state, and register them in the profile database 40.

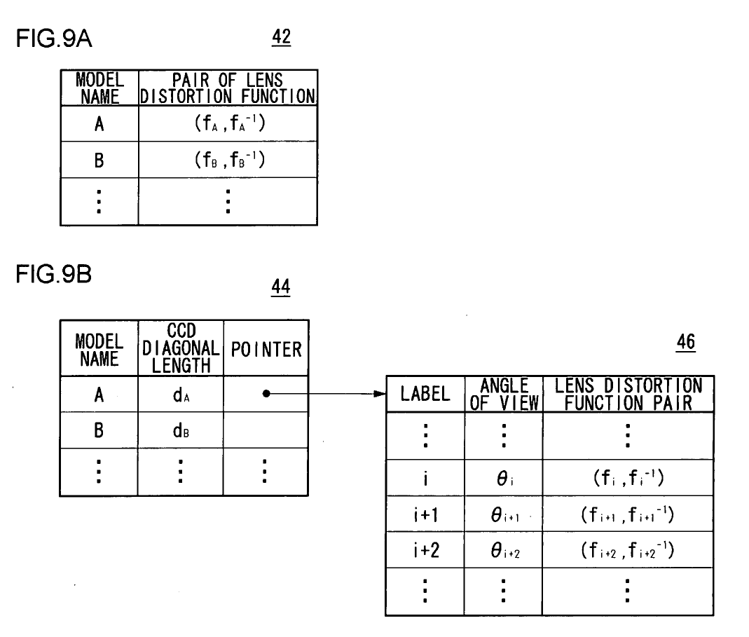

FIGS. 9A and 9B are diagrams for explaining lens distortion function pairs to be stored in the profile database 40. FIG. 9A shows the structure of the database on lens distortion function pairs for a single-focus lens. With a single-focus lens, the profile database 40 contains a table 42 in which the model names of cameras are stored in association with respective lens distortion function pairs. Here, the model name A is associated with a lens distortion function pair (f_{A}, f_{A}⁻¹), and the model name B a lens distortion function pair (f_{B}, f_{B}⁻¹).

FIG. 9B shows the structure of the database on lens distortion function pairs for a zoom lens. With a zoom lens, the profile database 40 contains a table 44 in which the model names of cameras are stored in association with the diagonal lengths of the CCDs of the cameras and pointers to lens distortion function pair tables. Here, the model name A is associated with a diagonal length d_{A} and a pointer to a lens distortion function pair table 46.

The lens distortion function pair table 46 is one for situations where the zoom lens of the camera having the model name A is changed in magnification. Labeling the angles of view with i, the lens distortion function pair table 46 contains labels i, the angles of view θᵢ, and lens distortion function pairs (fᵢ, fᵢ⁻¹) in association with one another. This lens distortion function pair table 46 may contain the lens distortion function pairs (fᵢ, fᵢ⁻¹) in association with focal lengths or zoom magnifications instead of the angles of view. In that case, the diagonal lengths d of the CCDs need not be stored in the database since a lens distortion function can be selected uniquely based on the focal length even without arithmetically calculating θᵢ to select the lens distortion function pairs.

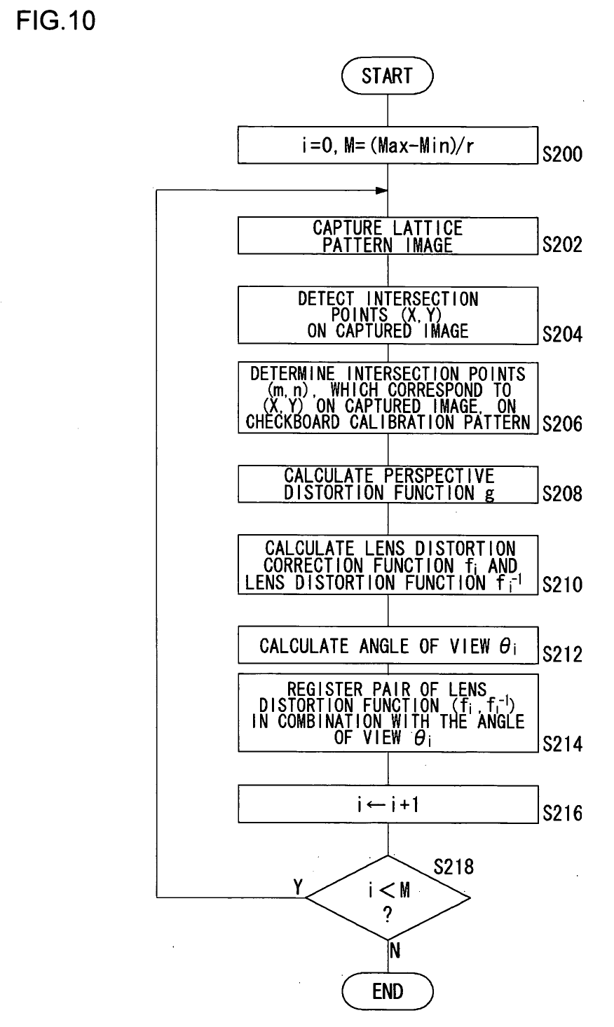

FIG. 10 is a flowchart for explaining the steps by which the electronic watermark extracting apparatus 200 creates the profile database 40.

The profile creation unit 38 initializes a variable i to 0, and determines the value of a constant M by the equation M=(Max−Min)/r (S200). Here, Min and Max are the minimum magnification and maximum magnification of the zoom lens, respectively, and r is the minimum unit of change in magnification. For a single-focus lens, M=0.

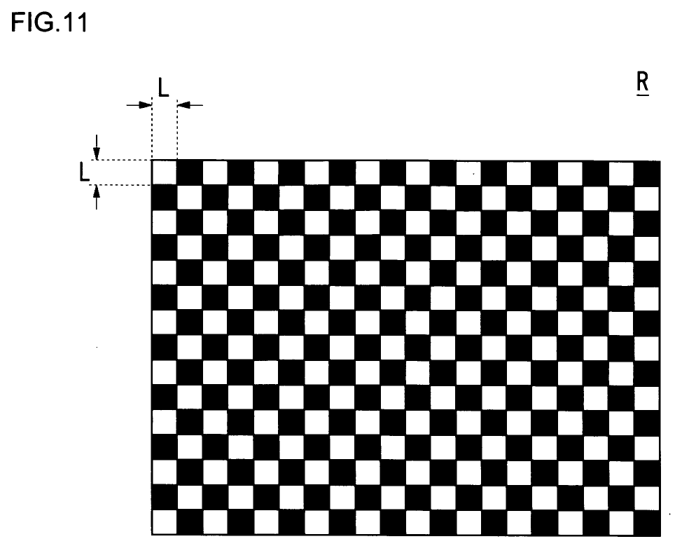

The capturing unit 30 captures a lattice pattern image R (S202). FIG. 11 is a diagram for explaining the lattice pattern image R to be used as a calibration pattern. For example, the lattice pattern image R has a checkered pattern, consisting of checks having a size of L×L pixels. The lattice size L of the lattice patterned image R is about the same as the block size N of the watermark according to the block embedding method employed by the electronic watermark embedding apparatus 100. For example, when the block size N is eight, the lattice size L may be eight or so. It should be noted that the block size N shall be set uniformly throughout this electronic watermark system, or be notified to the electronic watermark extracting apparatus 200 in some way in advance.

The lattice pattern image R is captured under the following condition:

[Capturing Condition]
(1) The image of the lattice pattern image R formed on the CCD surface has a height equal to the diagonal length d of the CCD, an inherent value of the capturing apparatus. In other words, the lattice pattern image R is imaged on the entire CCD surface so that the lattice pattern image R is displayed on the entire display screen of the capturing apparatus.
(2) The plane that includes the lattice pattern image R is in perfect focus in terms of definition 1.

When capturing the lattice pattern image R with a camera, it is difficult to capture the image from exactly right above. There occurs some perspective distortion due to deviations of the optical axis. Then, processing for correcting the perspective distortion is performed initially.

The perspective distortion function calculation unit 80 detects the imaging positions of the intersections in the lattice pattern of the captured image of the lattice pattern image R (S204). Suppose that the number of intersections in the lattice pattern detected is N, and the coordinates of the respective intersections are (Xₖ, Yₖ) (k=0, . . . , N−1).

Next, the perspective distortion function calculation unit 80 determines pattern positions (mₖ, nₖ) on the lattice pattern image R (k=0, . . . , N−1) corresponding to the detected intersections (Xₖ, Yₖ) (k=0, . . . , N−1), respectively (S206). The pattern positions (mₖ, nₖ) show the coordinates of the intersections in the lattice pattern on the distortion-free lattice pattern image R. Since the lattice arrangement of the lattice pattern image R is known in advance, it is easily possible to determine the pattern positions (mₖ, nₖ) corresponding to the coordinates (Xₖ, Yₖ) of the intersections on the captured image of the lattice pattern image R.

The perspective distortion function calculation unit 80 calculates a perspective distortion function g based on the relationship between the positions (Xₖ, Yₖ) of the intersections on the captured image of the lattice pattern image R and the corresponding pattern positions (mₖ, nₖ) (S208). Here, the perspective distortion function g is determined not by using all the intersections but by using only intersections lying near the center of the captured image of the lattice pattern image R. For example, a fourth of all the intersections are used as the intersections lying near the center. The reason for this is that the areas closer to the center are less susceptible to lens distortion, and the perspective distortion function g can thus be determined more accurately.

It is known that the imaging positions (Xₖ, Yₖ) of the intersections on the captured image of the lattice pattern image R and the corresponding pattern positions (mₖ, nₖ) have the following relationship. This property is described in “GAZO RIKAI, 3JIGEN-NINSHIKI NO SURI (Image Understanding: A Mathematical Approach to 3D Recognition)” KANAYA Ken'ichi, Morikita Shuppan, 1990.
Xₖ=(cmₖ+dnₖ+e)/(amₖ+bnₖ+1), and
Yₖ=(fmₖ+gnₖ+h)/(amₖ+bnₖ+1).

Given pairs of corresponding points {(Xₖ, Yₖ)} and {(mₖ, nₖ)}, where k=0, . . . , (N−1)/4, the coefficients a to h in the foregoing equations are determined by using a least-square method as follows:
J=Σₖ₌₀^{(N-1)/4}[(Xₖ(amₖ+bnₖ+1)−(cmₖ+dnₖ+e))²+(Yₖ(amₖ+bnₖ+1)−(fmₖ+gnₖ+h))²]→min.

The coefficients a to h that minimize J can be determined by solving the foregoing equation for ∂J/∂a=0, . . . , ∂J/∂h=0.

Consequently, the perspective distortion function g for mapping the pattern positions (mₖ, nₖ) onto the reference positions (Xₖ′, Yₖ′) of the intersections on the captured image of the lattice pattern image R is determined:
(Xₖ′, Yₖ′)=g(mₖ, nₖ), where k=0, . . . , N−1.

Next, processing for determining a lens distortion function pair is performed based on the perspective distortion function g calculated. The lens distortion function pair calculation unit 82 maps all the pattern positions (mₖ, nₖ) (k=0, . . . , N−1) by using the calculated perspective distortion function g, thereby determining the reference positions (Xₖ′, Yₖ′) (k=0, . . . , N−1).

The imaging positions (Xₖ, Yₖ) of the intersections on the captured image of the lattice pattern image R are off the original positions due to both perspective distortion and lens distortion. Meanwhile, the reference positions (Xₖ′, Yₖ′) onto which the pattern positions (mₖ, nₖ) are mapped by using the perspective distortion function g are off the original positions due to the perspective distortion alone. That is, the deviations between the reference positions (Xₖ′, Yₖ′) and the imaging positions (Xₖ, Yₖ) of the intersections on the captured image are ascribable to the lens distortion. The relationship therebetween can thus be examined to determine the lens distortion correction function fᵢ for resolving the lens distortion.

Based on the pairs of corresponding points {(Xₖ′, Yₖ′)} and {(Xₖ, Yₖ)} (k=0, . . . , N−1), the lens distortion function pair calculation unit 82 calculates the lens distortion correction function fᵢ (S210) by the following polynominal equations:
Xₖ′=a₁Xₖ⁴+b₁Xₖ³Yₖ+c₁Xₖ²Yₖ²+d₁XₖYₖ³+e₁Yₖ⁴+g₁Xₖ³+h₁Xₖ²Yₖ+i₁XₖYₖ²+j₁Yₖ³+k₁Xₖ²+l₁XₖYₖ+m₁Yₖ²+n₁Xₖ+o₁Yₖ+p₁,
and
Yₖ′=a₂Xₖ⁴+b₂Xₖ³Yₖ+c₂Xₖ²Yₖ²+d₂XₖYₖ³+e₂Yₖ⁴+g₂Xₖ³+h₂Xₖ²Yₖ+i₂XₖYₖ²+j₂Yₖ³+k₂Xₖ²+l₂XₖYₖ+m₂Yₖ²+n₂Xₖ+o₂Yₖ+p₂.

Here, the coefficients a₁ to p₁ and a₂ to p₂ are calculated by a least-square method as follows:
J=Σₖ₌₀^{N-1}[(X_{k′-}a₁Xₖ⁴+b₁Xₖ³Yₖ+c₁Xₖ²Yₖ²+d₁XₖYₖ³+e₁Yₖ⁴+g₁Xₖ³+h₁Xₖ²Yₖ+i₁XₖYₖ²+j₁Yₖ³+k₁Xₖ²+l₁XₖYₖ+m₁Yₖ²+n₁Xₖ+o₁Yₖ+p₁))²+(Y_{k′-}a₂Xₖ⁴+b₂Xₖ³Yₖ+c₂Xₖ²Yₖ²+d₂XₖYₖ³+e₂Yₖ⁴+g₂Xₖ³+h₂Xₖ²Yₖ+i₂XₖYₖ²+j₂Yₖ³+k₂Xₖ²+l₂XₖYₖ+m₂Yₖ²+n₂Xₖ+o₂Yₖ+p₂))²]→min.

Consequently, the lens distortion correction function fᵢ for expressing the relationship between the positions (Xₖ, Yₖ) of the intersections on the captured image and the reference positions (Xₖ′, Yₖ′) is obtained. Then, since the image correction requires two-way calculations, the lens distortion function fᵢ⁻¹, or an approximate inverse function of the lens distortion correction function fᵢ, is also determined. As is the case with the lens distortion correction function fᵢ, the lens distortion function fᵢ⁻¹ is calculated by using a least-square method:
(Xₖ′, Yₖ′)=fᵢ(Xₖ, Yₖ), where k=0, . . . , N−1, and
(Xₖ, Yₖ)=fᵢ⁻¹(Xₖ′, Yₖ′), where k=0, . . . , N−1.

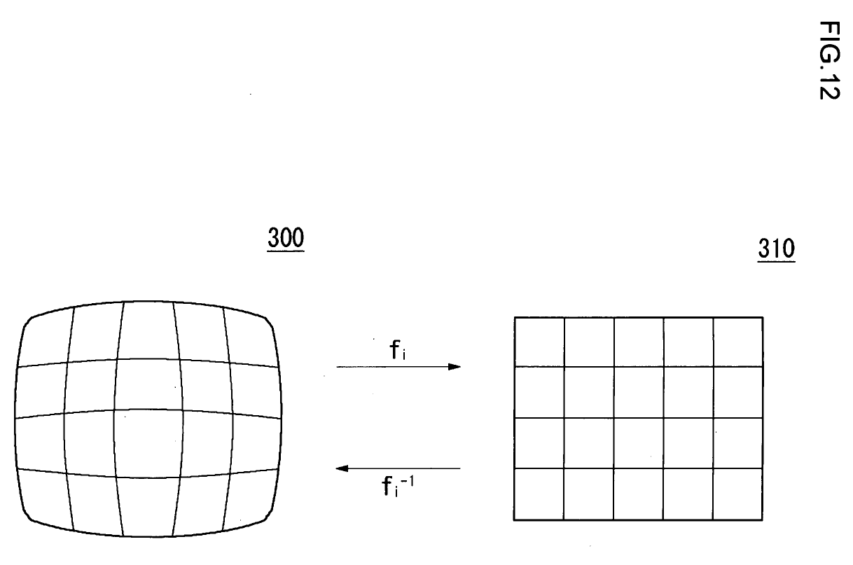

FIG. 12 is a diagram for explaining a lens distortion function pair (fᵢ, fᵢ⁻¹). In general, captured images are deformed in a barrel shape or pincushion shape due to lens distortion. An image 300 having lens distortion ascribable to capturing is transformed into an image 310 having no lens distortion by the lens distortion correction function fᵢ. Conversely, the image 310 having no lens distortion is transformed into the lens-distorted image 300 by the lens distortion function fᵢ⁻¹.

Return now to FIG. 10. The lens distortion function pair calculation unit 82 determines the angle of view θᵢ employed at the time of capturing from the focal length fᵢ and the diagonal length d of the CCD surface (S212) by using the following equation. If the captured image of the lattice pattern image R is provided in EXIF (Exchangeable Image File Format), the focal length fᵢ at the time of capturing can be acquired from the EXIF information included in the image data:
θᵢ=tan⁻¹(d/2fᵢ).

The lens distortion function pair registration unit 84 registers the lens distortion function pair (fᵢ, fᵢ⁻¹) into the profile database 40 (S214) in association with the angle of view θᵢ (S214).

The variable i is incremented by one (S216). If the variable is smaller than M (Y at S218), the processing returns to step S202. The lattice pattern image R is captured again with a zoom magnification of the next level, followed by the processing of calculating the perspective distortion function g and the lens distortion function pairs (fᵢ, fᵢ⁻¹). If the variable i is not smaller than M (N at S218), the processing for creating the profile database 40 ends.

Consequently, in the case of a single-focus lens, a single lens distortion function pair (f, fᵢ⁻¹) is registered in the profile database 40. With a zoom lens, the angles of view θi and the lens distortion function pairs (fᵢ, fᵢ⁻¹) at respective magnifications are registered in the profile database 40 in association with each other.

Description will now be given of the steps by which the electronic watermark extracting apparatus 200 having the foregoing configuration extracts an electronic watermark.

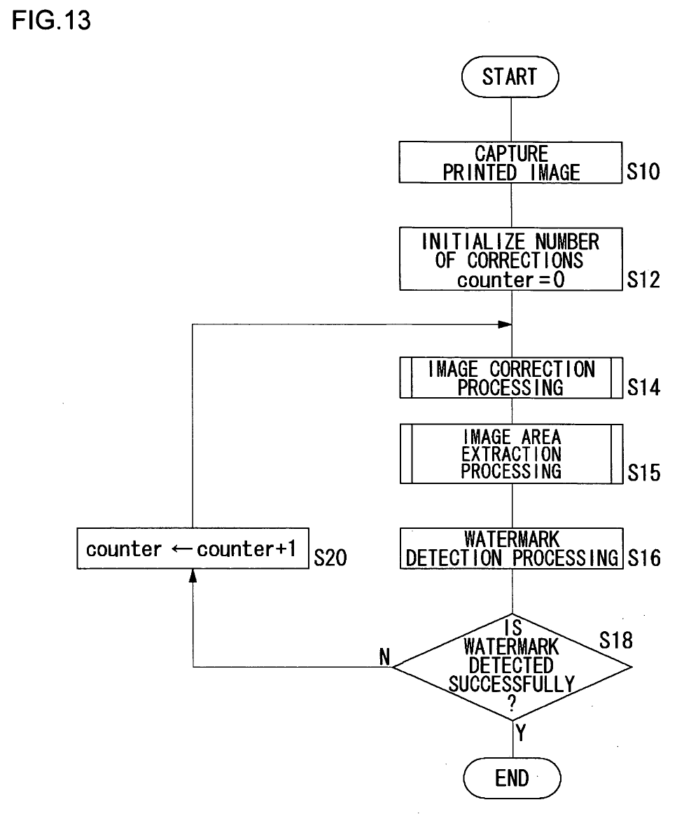

FIG. 13 is a flowchart showing the overall flow of the steps for extracting an electronic watermark. The capturing unit 30 captures a printed image P (S10). The image correction unit 34 initializes the number of corrections “counter” so that counter=0 (S12).

The image correction unit 34 performs image correction processing to be detailed later on the image of the printed image P captured by the capturing unit 30 (S14). Hereinafter, distorted images to be corrected will be referred to as “correction object images.” Distortion-free images to be the targets of the correction will be referred to as “correction target images.” In the image correction processing S14, coordinates (i, j) on the correction target image are transformed into coordinates (xᵢⱼ, Yᵢⱼ) on the correction object image by using a lens distortion function stored in the profile database 40. Luminance values in the respective coordinates (xᵢⱼ, yᵢⱼ) are then determined by bi-linear interpolation or the like, and set as the luminance values in the original coordinates (i, j) on the correction target image.

The image area determination unit 32 determines the original image area 20 in the captured image whose distortion is corrected by the image correction unit 34 (S15). The watermark extraction unit 36 performs processing for detecting watermark information X from the original image area determined by the image area determination unit 32 (S16). This watermark detection processing is performed by detecting watermark bits from the original image area 20 in units of blocks. The watermark extraction unit 36 checks if significant watermark information X is obtained, thereby determining whether a watermark is detected successfully or not (S18).

If a watermark is detected successfully (Y at S18), the processing ends. If the watermark detection fails (N at S18), the number of corrections counter is incremented by one (S20). The processing returns to step S14 to repeat the image correction processing and try watermark detection again. Here, thresholds and other parameters are adjusted to select a lens distortion function from the profile database 40 again before the image correction processing is performed to retry the watermark detection. The number of corrections counter is incremented while the image correction processing and the watermark detection processing are repeated until a watermark is detected successfully.

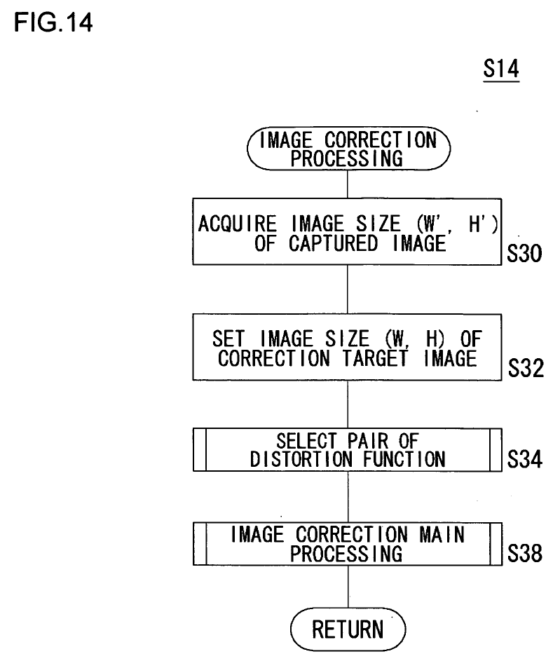

FIG. 14 is a flowchart for showing a general flow of the image correction processing S14 of FIG. 13. The image correction unit 34 acquires the image size (W′, H′) of the correction object image, assuming that the entire captured image of the printed image P as the correction object image (S30). Next, the image correction unit 34 sets the image size (W, H) of the correction target image (S32). The distortion correction will eventually transform the captured image into an image having W pixels in the horizontal direction and H pixels in the vertical direction.

The lens distortion function pair selection unit 86 of the image correction unit 34 makes an inquiry to the profile database 40, thereby acquiring the lens distortion function pair corresponding to the angle of view employed at the time of capturing (S34). The lens distortion correction processing unit 88 performs image correction main processing by using the lens distortion function acquired by the lens distortion function pair selection unit 86 (S38).

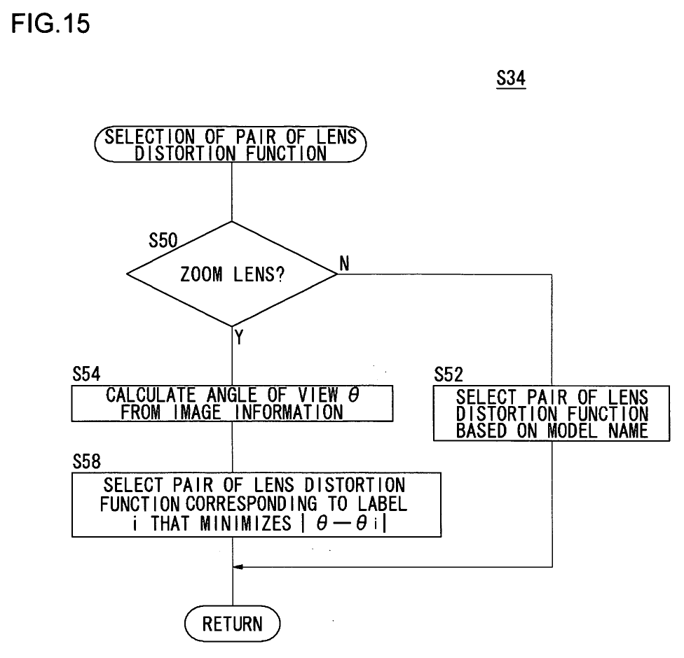

FIG. 15 is a flowchart showing the detailed steps for selecting a lens distortion function pair at S34 of FIG. 14. Initially, the lens distortion function pair selection unit 86 determines if the lens of the camera used for capturing is a zoom lens (S50). This determination can be made depending on whether or not the EXIF information included in the correction object image contains any item pertaining to the focal length.

If not a zoom lens (N at S50), the lens distortion function pair selection unit 86 acquires the model name of the camera used for capturing from the EXIF information on the correction object image. The lens distortion function pair selection unit 86 makes an inquiry to the profile database 40 with the model name as a key, acquires the lens distortion function pair associated with the model name (S52), and ends the processing.

If a zoom lens (Y at S50), the lens distortion function pair selection unit 86 calculates the angle of view θ from the EXIF information included in the correction object image (S54). The angle of view θ is calculated on the assumption that the following precondition holds:

[Precondition]

The subject is in perfect focus.

That is, pictures out of focus can cause errors when corrected. Under the foregoing precondition, the lens distortion function pair selection unit 86 acquires the diagonal length d of the CCD of the camera from the profile database 40, and acquires the capturing focal length f from the EXIF information of the correction object image. The lens distortion function pair selection unit 86 then calculates the angle of view θ by the following equation:
θ=tan⁻¹(d/2f).

The lens distortion function pair selection unit 86 searches the profile database 40 with the model name obtained from the EXIF information and the angle of view θ calculated at step S54 as a key. The lens distortion function pair selection unit 86 thereby selects the lens distortion function pair (fᵢ, fᵢ⁻¹) corresponding to a label i that minimizes the difference |θ−θᵢ| between the angle of view θᵢ registered in the profile database 40 and the angle of view θ calculated (S58), and ends the processing.

Hereinafter, a lens distortion function pair that the lens distortion function pair selection unit 86 thus acquires from the profile database 40 will be denoted as (F, F⁻¹).

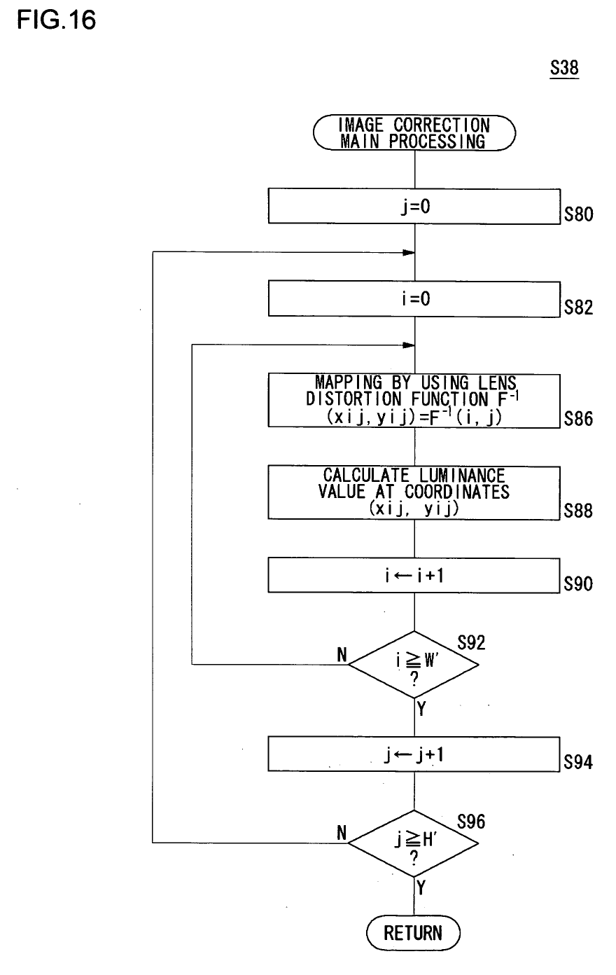

FIG. 16 is a flowchart showing the detailed steps of the image correction main processing S38 of FIG. 14. The lens distortion correction processing unit 88 initializes the y-coordinate value j of the correction target image to 0 (S80). Next, it initializes the x-coordinate value i of the correction target image to 0 (S82).

The lens distortion correction processing unit 88 maps a point P(i, j) in the correction target image onto a point Q(xᵢⱼ, yᵢⱼ) in the correction object image (S86) by using the lens distortion function F⁻¹:
(xᵢⱼ, yᵢⱼ)=F⁻¹(i, j).

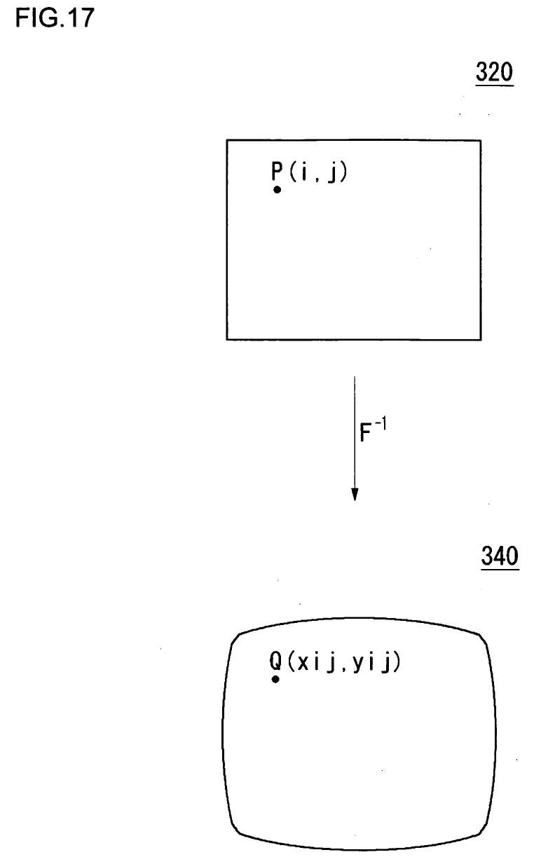

FIG. 17 is a diagram for explaining how a point in a correction target image is mapped onto a point in a correction object image. A correction target image 320 is an image having no lens distortion. A correction object image 340 is a lens-distorted image. The point P(i, j) in the correction target image 320 is mapped onto the point Q(xᵢⱼ, yᵢⱼ) in the correction object image 340 by the lens distortion function F⁻¹.

The lens distortion correction processing unit 88 calculates the luminance value L(xᵢⱼ, yᵢⱼ) at the point Q(xᵢⱼ, yᵢⱼ) by interpolating the luminance values of peripheral pixels by using a bi-linear interpolation method or the like. The luminance value L(xᵢⱼ, yᵢⱼ) calculated is set as the luminance value at the point P(i, j) of the correction target image (S88).

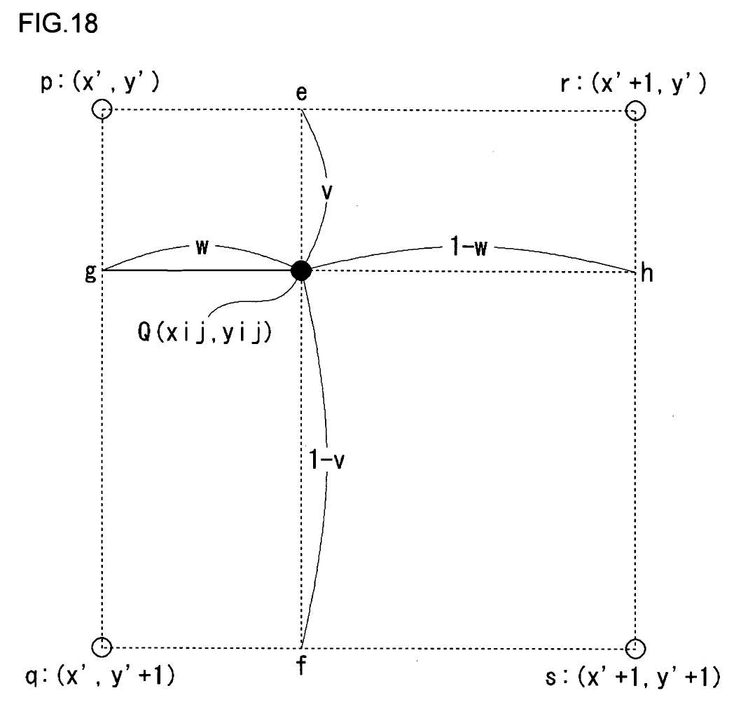

FIG. 18 is a diagram for explaining the method of calculating the luminance value L(xᵢⱼ, yᵢⱼ) at the point Q(xᵢⱼ, yᵢⱼ) which is mapped by the lens distortion function F⁻¹. Suppose that four pixels p, q, r, and s lie in the vicinity of the point Q(xᵢⱼ, yᵢⱼ), and have coordinates (x′, y′), (x′, y′+1), (x′+1, y′), and (x′+1, y′+1), respectively. The feet of perpendiculars drawn from the point Q to the sides pr and qs will be represented by points e and f, respectively. The feet of perpendiculars drawn from the point Q to the sides pq and rs will be represented by points g and h, respectively.

The point Q is one that divides the segment ef at an internal division ratio of v:(1−v), and divides the segment gh at an internal division ratio of w:(1−w). The luminance value L(xᵢⱼ, yᵢⱼ) at the point Q is determined from the luminance values L(x′, y′), L(x′, y′+1), L(x′+1, y′), and L(x′+1, y′+1) at the four points p, q, r, and s by bi-linear interpolation as shown by the following equation:
L(xᵢⱼ, yᵢⱼ)=(1−v)×{(1−w)×L(x′, y′)+w×L(x′+1, y′)}+v×{(1−w)×L(x′, y′+1)+w×L(x′+1, y′+1)}.

While the luminance value at the point Q is determined by interpolating the luminance values of four pixels nearby, the method of interpolation is not limited thereto. More than four pixel points may be also used for interpolation.

Referring to FIG. 16, after the processing of step S88, the x-coordinate value i is incremented by one (S90). If the x-coordinate value i is smaller than the width W′ of the correction object image (N at S92), the processing returns to step S86. The processing for determining the luminance value of a pixel is thus repeated while increasing the coordinate value in the x-axis direction.

If the x-coordinate value i reaches or exceeds the width W′ of the correction object image (Y at S92), it means that the luminance values of the pixels at the current y-coordinate value j are obtained through the x-axis direction. The y-coordinate value j is then incremented by one (S94). If the y-coordinate value j reaches or exceeds the height H′ of the correction object image (Y at S96), the processing ends since the luminance values are obtained of all the pixels of the correction target image. If the y-coordinate value j is smaller than the height H′ of the correction object image (N at S96), the processing returns to step S82. The x-coordinate value is thus initialized to zero again, and the processing for determining the luminance value of a pixel is repeated while the coordinate value is increased in the x-axis direction under the new y-coordinate value j.

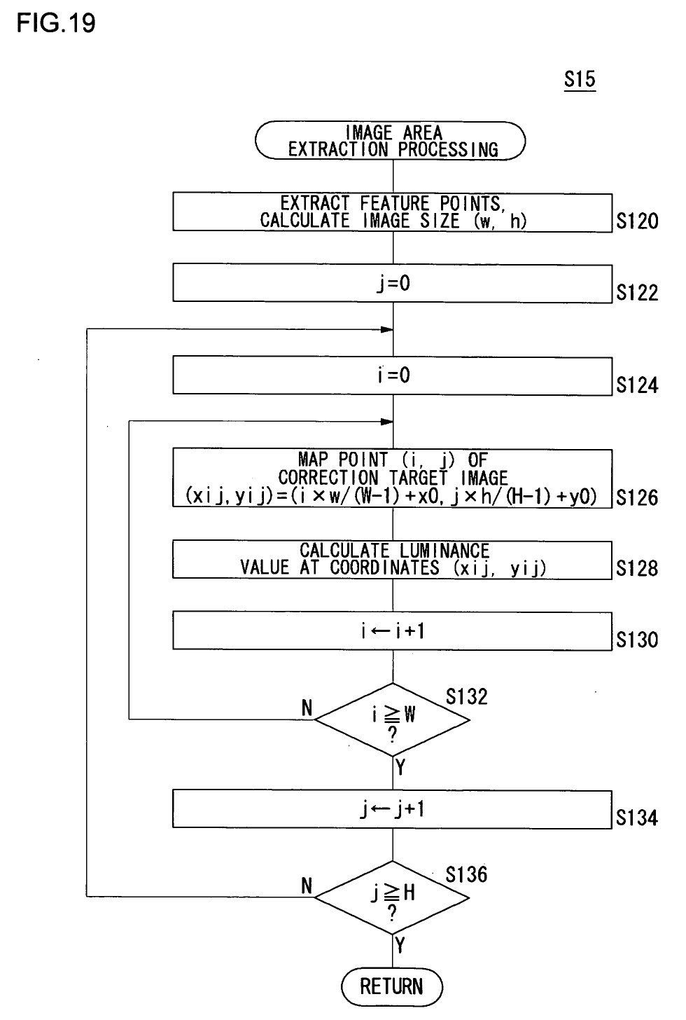

FIG. 19 is a flowchart showing the detailed steps of the image area determination processing S15 of FIG. 13. The image area determination unit 32 extracts feature points from the image whose lens distortion is corrected by the image correction unit 34, and calculates an image size (w, h) (S120).

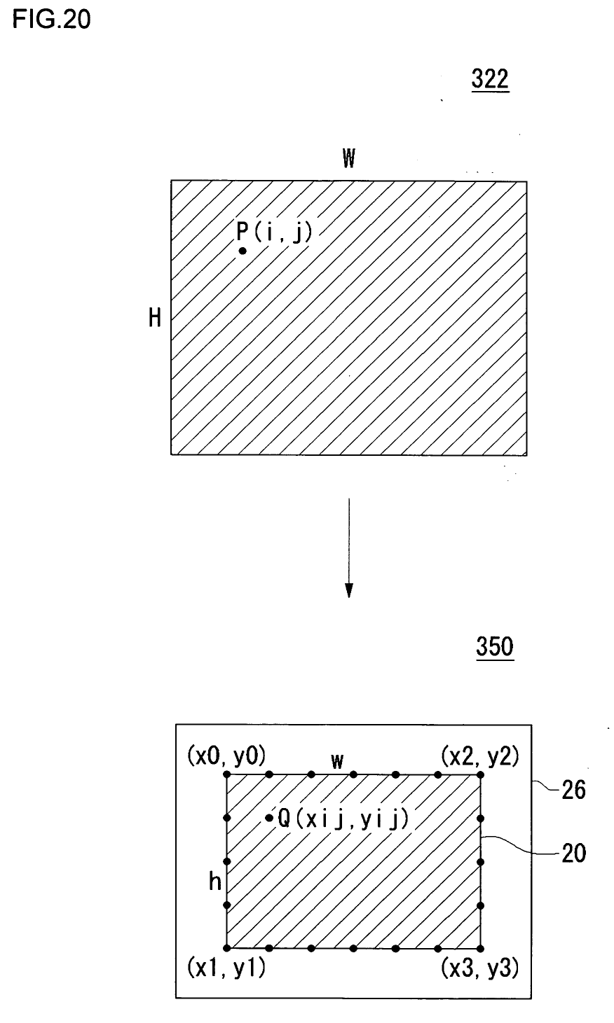

FIG. 20 is a diagram for explaining how feature points are extracted from a lens-distortion-corrected image 350. A correction target image 322 of the diagram corresponds to the original image area 20 of the lens-distortion-corrected image 350, and has a size of W in width and H in height. The image area determination unit 32 detects vertexes at the four corners of the original image area 20 and points on each side, which are shown by dots, as feature points of the lens-distortion-corrected image 350. Since its lens distortion is eliminated by the image correction unit 34, the lens-distortion-corrected image 350 has four sides of straight shape which can be detected easily by edge extraction processing or the like. The coordinate values of the vertexes at the four corners, or (x0, y0), (x1, y1), (x2, y2), and (x3, y3), can be determined accurately from the rows of feature points detected. Using the coordinate values of these vertexes at the four corners, the width w and the height h of the original image area 20 can be calculated by the following equations:
w=x2−x0=x3−x1, and
h=y1−y0=y3−y2.

The image area determination unit 32 initializes the y-coordinate value j of the correction target image to 0 (S122). Next, it initializes the x-coordinate value i of the correction target image to 0 (S124).

The image area determination unit 32 maps a point P(i, j) in the correction target image onto a point Q(xᵢⱼ, yᵢⱼ) in the lens distortion corrected image as shown in FIG. 20 (S126) by the following equations:
xᵢⱼ=i×w/(W−1)+x0, and
yᵢⱼ=j×h/(H−1)+y0.

The image area determination unit 32 calculates the luminance value L(xᵢⱼ, yᵢⱼ) at the point Q(xᵢⱼ, yᵢⱼ) by interpolating the luminance values of peripheral pixels by using a bi-linear interpolation method or the like. The luminance value L(xᵢⱼ, yᵢⱼ) calculated is set as the luminance value at the point P(i, j) of the correction target image (S128).

The image area determination unit 32 increments the x-coordinate value i by one (S130). If the x-coordinate value i is smaller than the width W of the correction target image (N at S132), the image area determination unit 32 returns to step S126. The processing for determining the luminance value of a pixel is thus repeated while increasing the coordinate value in the x-axis direction.

If the x-coordinate value i reaches or exceeds the width W of the correction target image (Y at S132), it means that the luminance values of the pixels at the current y-coordinate value j are obtained through the x-axis direction. The y-coordinate value j is then incremented by one (S134). If the y-coordinate value j reaches or exceeds the height H of the correction target image (Y at S136), the processing ends since the luminance values are obtained of all the pixels of the correction target image. If the y-coordinate value j is smaller than the height H of the correction target image (N at S136), the processing returns to step S124. The x-coordinate value is thus initialized to zero again, and the processing for determining the luminance value of a pixel is repeated while the coordinate value is increased in the x-axis direction under the new y-coordinate value j.

Description will now be given of a modification of the present embodiment. When selecting a lens distortion function pair at S34 of FIG. 15, it is actually rare for the precondition that the subject is in perfect focus to hold. The angle of view θ calculated at step S54 thus has some errors. Errors can also occur during the calculation of the lens distortion function. Due to these system errors, selecting a lens distortion function pair corresponding to the calculated angle of view θ from the profile database 40 does not necessarily ensure that the selected lens distortion function pair is optimum one. For this reason, the method of making an inquiry to the profile database 40 by using the calculated angle of view θ as a key is selected from between the following two, depending on system requirements and the method of embedding electronic watermarks:

[Method of Selection for a Speed-Priority System]

This method applies when the foregoing system errors are allowable. To give priority to the processing speed, simply select the lens distortion function pair (fᵢ, fᵢ⁻¹) corresponding to a label i that minimizes the difference |θ−θᵢ| between the angle of view θᵢ registered in the profile database 40 and the angle of view θ calculated, similarly to step S58 shown in FIG. 15.

[Method of Selection for a Precision-Priority System]

This method applies when the system errors are not allowable. With reference to the angle of view θ calculated, acquire a plurality of lens distortion function pairs as candidates from the profile database 40. Pre-evaluate which of the lens distortion function pairs can best correct the image, and then select the lens distortion function pair of the highest evaluation.

For example, the method of selection for a speed-priority system is used when the size N of the watermark embedded blocks is large and the system errors have only a small impact. The method of selection for a speed-priority system is used when the size N of the watermark embedded blocks is small and the system errors have a significant impact. Alternatively, either of the methods may be specified depending on the characteristics of applications to which the present invention is applied. For example, in entertainment applications, the speed-priority method is selected since the response rate has a higher priority than the watermark detection rate. In the meantime, examples of applications for which the precision-priority method is selected include a ticket authentication system.

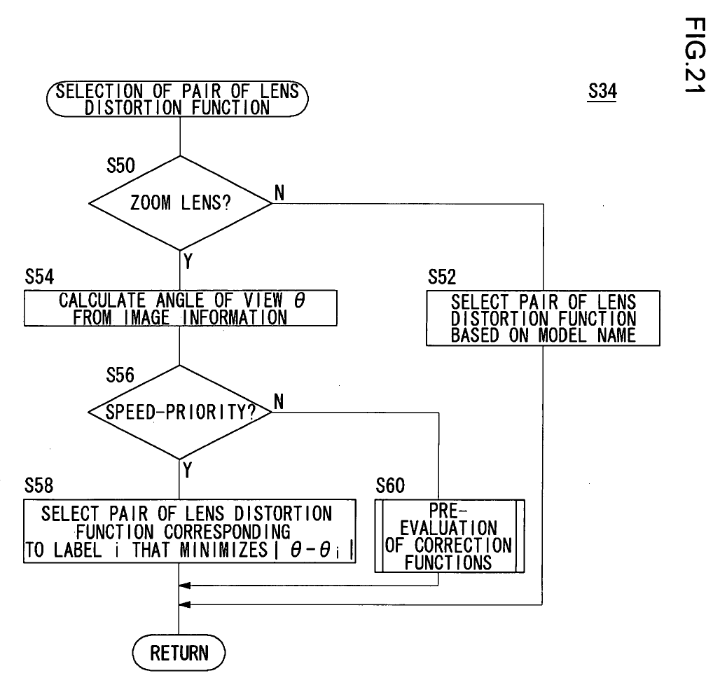

FIG. 21 is a flowchart for showing the detailed steps for selecting a lens distortion function pair (S34), where the method of selection for a speed-priority system and the method of selection for a precision-priority system can be switched. Description will be given only of differences from FIG. 15. The lens distortion function pair selection unit 86 determines whether priority is given to speed or not (S56). For example, the lens distortion function pair selection unit 86 selects either one of the speed-priority method and the precision-priority method automatically, depending on the size N of the watermark embedding blocks. Alternatively, either one of a speed-priority mode and a precision-priority mode may be specified by the user.

If priority is given to speed (Y at S56), step S58 is executed as in FIG. 15. If priority is not given to speed (N at S56), pre-evaluation is performed on correction functions (S60)

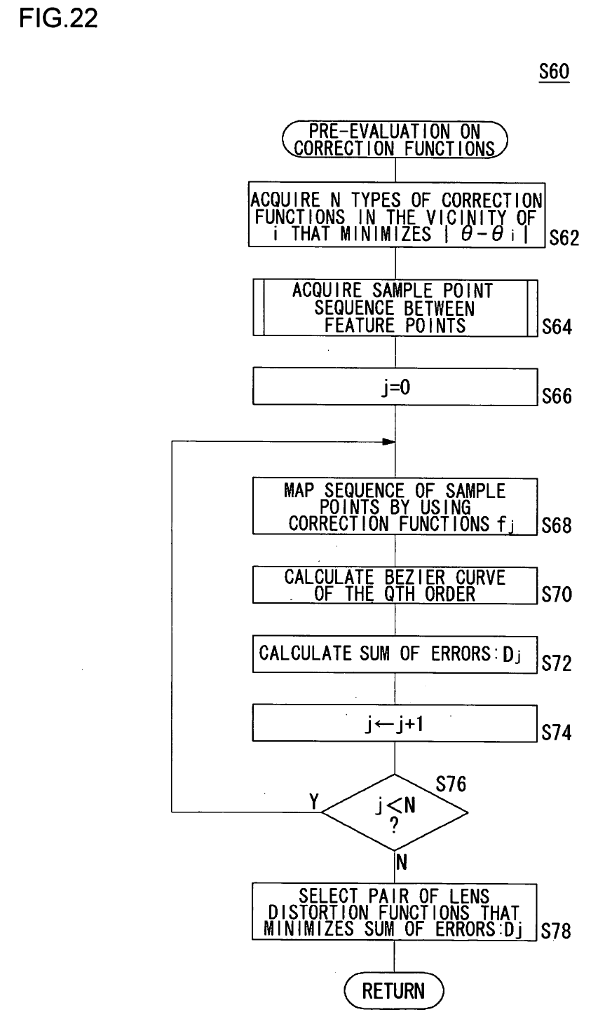

FIG. 22 is a flowchart showing the detailed steps for the pre-evaluation on correction functions at S60 of FIG. 21. The lens distortion function pair selection unit 86 acquires lens distortion correction functions fⱼ (j=0, 1, . . . , N−1) corresponding to N successive labels across a label i as candidates (S62). Here, the label i is one that minimizes the difference |θ−θᵢ| between the angle of view θᵢ registered in the profile database 40 and the angle of view θ calculated.

M feature points are defined on the correction object image, and a row of P sample points (Xₘ, Yₘ) (m=0, 1, . . . , P−1) are acquired between the feature points of the correction object image (S64). For example, when the correction object image is an oblong rectangular in shape, the feature points are the vertexes at the four corners. The row of sample points includes points sampled on each of the sides which connect the adjoining vertexes. Here, the row of sample points shall include the feature points lying on both ends. That is, both (X₀, Y₀) and (X_{P-1}, Y_{P-1}) are feature points. In another example, a row of points on the edge of an object in the correction object image, such as a personal figure, may be acquired as the row of sample points. For example, a row of sample points may be defined on the outline of a person's face or eye.

The number of sample points P is determined with reference to the lattice size L of such a lattice pattern image R as a checker pattern. For example, L takes on such values as 16 and 32. Since a row of sample points is determined between two feature points selected from among M feature points, the maximum possible number of combinations of feature points is _{M}C₂. These combinations are not applicable unless the lines connecting the feature points form a known shape.

The variable j is initialized to zero (S66). The row of sample points (Xₘ, Yₘ) (m=0, 1, . . . , P−1) are mapped by the lens distortion correction function fⱼ (S68). The row of sample points mapped by the lens distortion correction function fⱼ shall be denoted as (Xₘ^{j}, Yₘ^{j}) (m=0, 1, . . . , P−1):
(Xₘ^{j}, Yₘ^{j})=fⱼ(Xₘ, Yₘ), where m=0, 1, . . . , P−1.

Next, a Bezier curve H′ of qth order is calculated with the row of mapped sample points (Xₘ^{j}, Yₘ^{j}) (m=0, 1, . . . , P−1) as control points (S70). The order q is determined depending on what kind of line the row of sample points between the feature points are supposed to fall on if without lens distortion. When the correction target image is an oblong rectangular and the feature points are the vertexes at the four corners, the row of sample points between the feature points are supposed to fall on the sides of the oblong rectangular. In this case, the order is determined to be q=1. By the definition of Bezier curves, a Bezier curve of first order forms a straight line which connects between feature points.

The sum Dⱼ of errors between the calculated Bezier curve and the control points is calculated (S72) by the following equation:
Dⱼ=Σₘ₌₀^{P-1}[(Yₘ^{j}−(H′(Xₘ^{j})))²].
The foregoing equation is one for evaluating approximation errors of the Bezier curve when sampled in the x direction.

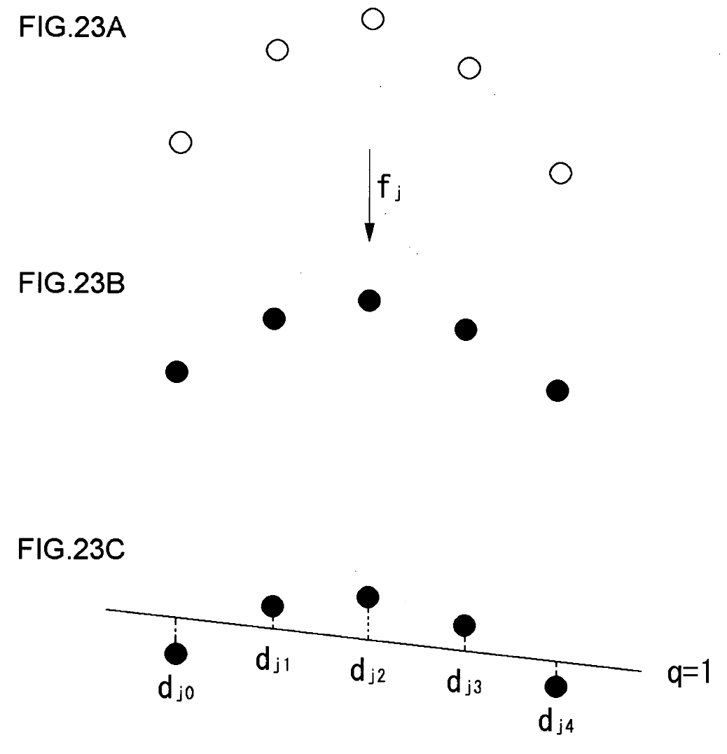

FIGS. 23A to 23C are diagrams for explaining how approximation errors of a Bezier curve are evaluated. FIG. 23A shows five sample points. FIG. 23B shows a row of sample points of FIG. 23A mapped by a lens distortion correction function fⱼ. FIG. 23C shows the state where a Bezier curve of q=1, i.e., a straight line is applied to the row of mapped sample points. The sample points have errors dⱼ₀ to dⱼ₄, respectively. The sum Dⱼ of errors is given by Dⱼ=dⱼ₀+dⱼ₁+dⱼ₂+dⱼ₃+dⱼ₄.

Return now to FIG. 22. The variable j is incremented by one (S74). If j is smaller than N (Y at S76), the lens distortion function pair selection unit 86 returns to step S68 and performs the processing for calculating the sum Dⱼ of errors as to the next lens distortion correction function fⱼ. If j is not smaller than N (N at S76), the lens distortion function pair selection unit 86 selects the lens distortion function pair (fⱼ, fⱼ⁻¹) corresponding to a label j that minimizes the sum Dⱼ of errors (j=0, 1, . . . , N−1) (S78), and ends the processing.

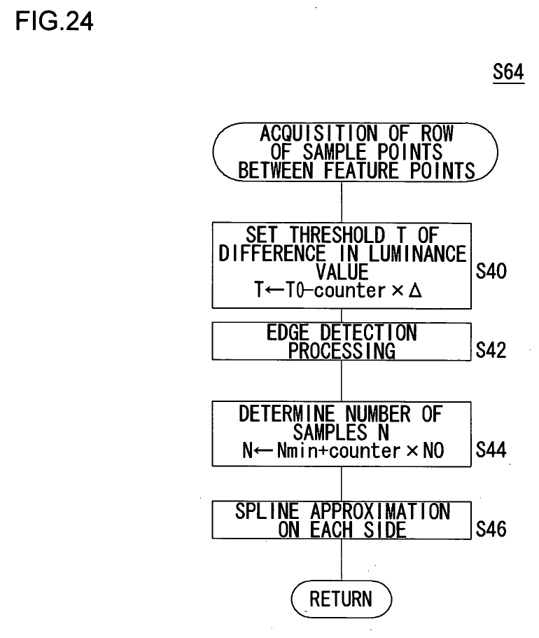

FIG. 24 is a flowchart showing the detailed steps for acquiring a row of sample points between feature points at S64 of FIG. 22. For example, the following description will deal with a method in which the image frame of the correction object image, i.e., the original image area 20 is detected to extract a row of sample points.

Initially, at step S40, a threshold T intended for edge determination is set. Here, the threshold T is given by T=T0−counter×Δ. As can be seen from the flowchart of FIG. 13, counter is the number of corrections. T0 is the threshold for the first correction. That is, each time the number of corrections increases, the threshold T is decreased by Δ and the processing of steps S14, S15, and S16 of FIG. 13 is performed.

For example, suppose that a pixel A lying at the end of a margin has a luminance value of 200, a pixel B lying at the end of the original image area 20 next to the foregoing pixel A has a luminance value of 90, T0 is 115, and Δ is 10. When a difference between the luminance values of the pixels A and B is greater than the threshold T, the pixels A and B shall be determined to have an edge therebetween. In the first correction (counter=0), the pixels A and B are determined not to have an edge therebetween since the difference between the luminance values is 110 and the threshold T is 115. In the second correction (counter=1), however, the pixels A and B are determined to have an edge therebetween since the threshold T falls to 105.

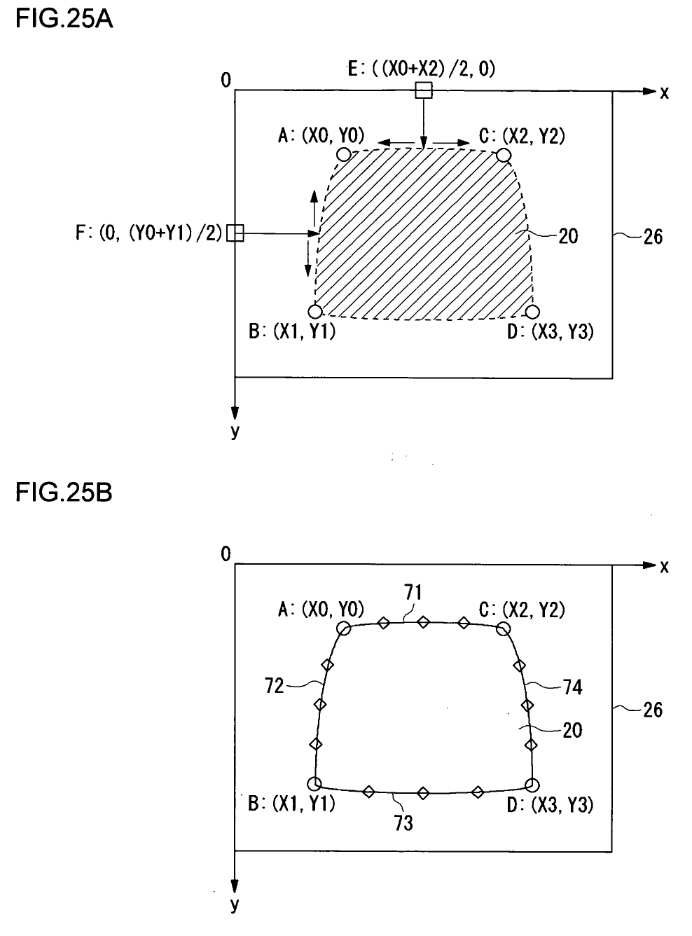

Next, at step S42, the image correction unit 34 performs edge detection processing. Here, the luminance difference between adjoining pixels is compared with the threshold T set at step S40, and if the difference is greater, the corresponding pixel is considered as an edge. FIG. 25A is a diagram for explaining how the edge detection processing is performed on the original image area 20. The coordinate system has an x-axis in the horizontal direction and a y-axis in the vertical direction, with the top left vertex of the captured area 26 as the point of origin. The original image area 20 shown hatched has four vertexes A, B, C, and D at coordinates (X0, Y0), (X1, Y1), (X2, Y2), and (X3, Y3), respectively. Starting from a point E((X0+X2)/2, 0) on the x-axis, pixels are scanned in the y-axis direction. If the luminance values of two pixels adjoining in the y-axis direction have a difference greater than the threshold T, the border between the two pixels is determined to be an edge. Then, starting from that point, pixels are scanned to the right and to the left in the x-axis direction, thereby searching for locations where a difference between the luminance values of two pixels adjoining in the y-axis direction exceeds the threshold T likewise. This detects the horizontal edges of the original image area 20.

Vertical edges are also detected likewise. Starting from a point F(0, (Y0+Y1)/2) on the y-axis, pixels are scanned in the x-axis direction. Locations where a difference between the luminance values of two pixels adjoining in the x-axis direction exceeds the threshold T are thus searched for, thereby detecting vertical edges of the original image area 20.

It should be noted that the foregoing has dealt with the case where the vertical or horizontal edges of the original image area 20 are detected based on a difference between the luminance values of two pixels adjoining in the y-axis or x-axis direction. Instead, edges may be detected by using edge detection templates. For example, edges may be detected based on the results of comparison between matching calculations obtained by using a Prewitt edge detector and a threshold T.

Note that the threshold T decreases from the initial value T0 as the number of corrections counter increases in value. The criterion for edge detection thus relaxes gradually with the increasing number of corrections. Extracting edges by using higher thresholds T can sometimes fail to detect edges properly due to noise in the captured image. In such cases, the value of the threshold T is lowered to detect edges with a relaxed criterion.

Returning to FIG. 24, the image correction unit 34 determines the number of samples N for making a curve approximation to each of the sides of the original image area 20. For example, N is set so that N=Nmin+counter×N0. Here, Nmin is a value to be determined depending on the order of the spline curve, and N0 is a constant. As the number of corrections counter increases, the number of samples N increases. This enhances the approximation accuracy on each side. The image correction unit 34 selects sample points as many as the fixed parameter N from among a row of edge-points detected at step S42, and makes a spline approximation to each side of the original image area 20 (S46). A row of sample points are obtained by sampling the points on the spline curve determined thus. Alternatively, the N sample points or control points of the spline curve may be used simply as a row of sample points.

FIG. 25B is a diagram for explaining the spline approximation to each side of the original image area 20. Sides 71, 72, 73, and 74 of the original image area 20 are each approximated, for example, with a cubic spline curve aⱼx³+bⱼx²+cⱼx+d by using three points on each side and two vertexes on both ends as the sample points. Here, the spline curve has four parameters, and Nmin is set so that Nmin=2. As the number of corrections increases, the image correction unit 34 may increase the number of samples N and the order of the spline curve as well. The order can be increased to obtain more accurate shapes of the respective sides of the original image area 20 on the captured printed image P.

As has been described, according to the electronic watermark extracting apparatus 200 of the present embodiment, lens distortion function pairs for respective angles of view are prepared in the database in advance. Then, lens distortion is corrected by using a lens distortion function pair corresponding to the angle of view employed at the time of capturing. The distortion occurring in the image can thus be corrected with high precision, which can increase the frequency of detection of electronic watermarks.

The angle of view calculated and the lens distortion correction functions registered contain some errors, whereas the lens distortion correction functions can be pre-evaluated to select more suitable lens distortion correction functions. Moreover, whether or not to make a pre-evaluation on the lens distortion correction functions can be determined depending on the size of the embedded blocks of electronic watermarks. Since image distortion can thus be corrected with precision suited to the tolerance of the electronic watermarks for image distortion, it is possible to avoid needless distortion correction processing while maintaining the detection accuracy of the watermarks.

### Second Embodiment

The first embodiment has been dealt with the case of performing a lens distortion correction alone, on the assumption that the correction object image has no perspective distortion or the effect of perspective distortion is as small as negligible. In the second embodiment, in contrast, the perspective distortion of the correction object image will also be corrected. Since the rest of the configuration and operation are the same as in the first embodiment, description will be given only of differences from the first embodiment.

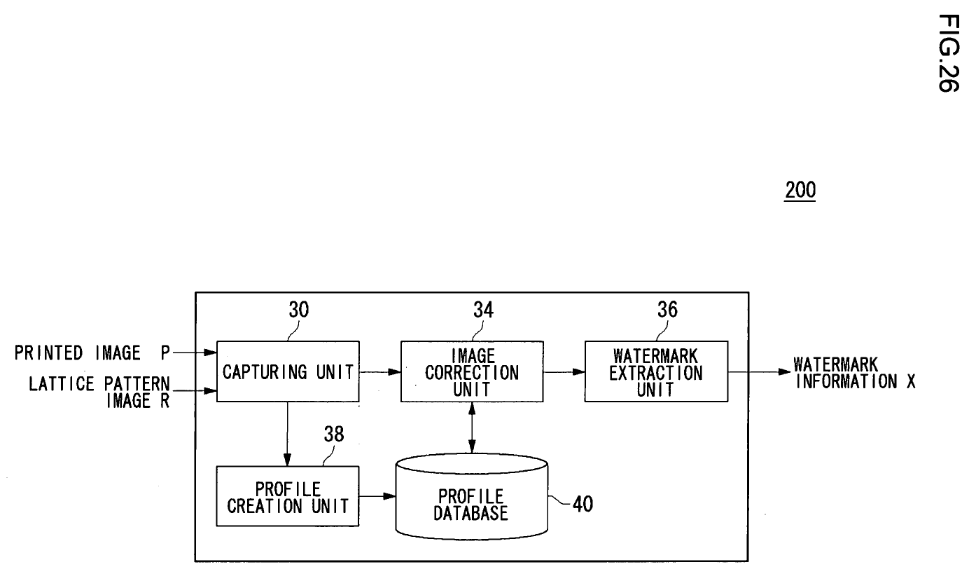

FIG. 26 is a block diagram showing the electronic watermark extracting apparatus 200 according to the second embodiment. In the electronic watermark extracting apparatus 200 according to the first embodiment shown in FIG. 4, the image correction unit 34 corrects the lens distortion of the captured image before the image area determination unit 32 cuts out the original image area 20 from the lens-distortion-corrected image. The present embodiment, on the other hand, is configured without the image area determination unit 32. The reason for this is that the image correction unit 34 also performs the processing of cutting out the original image area 20 while performing correction processing on perspective distortion. Consequently, in the present embodiment, the image correction unit 34 supplies the lens- and perspective-distortion-corrected original image area 20 to the watermark extraction unit 36 directly. The watermark extraction unit 36 then extracts watermark information X embedded in the distortion-corrected original image area 20.

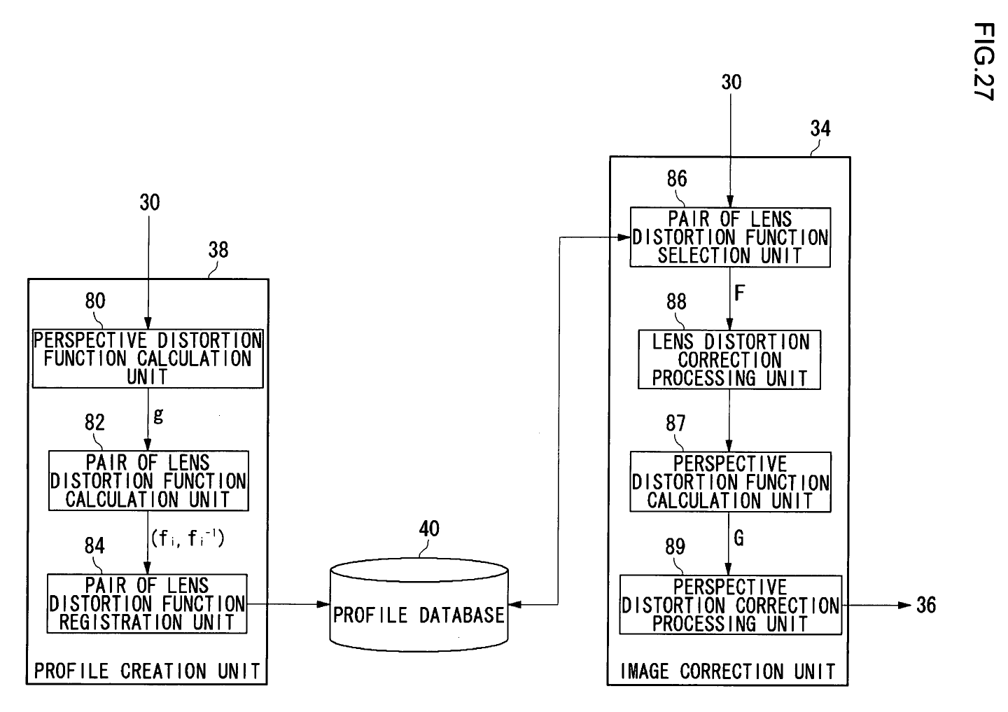

FIG. 27 is a diagram for explaining the detailed configuration of the profile creation unit 38 and the image correction unit 34 according to the second embodiment. The profile creation unit 38 has the same configuration as that of the profile creation unit 38 of the first embodiment shown in FIG. 7.

The image correction unit 34 according to the present embodiment includes a lens distortion function pair selection unit 86, a lens distortion correction processing unit 88, a perspective distortion function calculation unit 87, and a perspective distortion correction processing unit 89.

The capturing unit 30 supplies a captured printed image P to the image correction unit 34. The lens distortion function pair selection unit 86 of the image correction unit 34 accepts the input of the captured image of the printed image P, and determines from the image information the angle of view θ employed at the time of capturing. The lens distortion function pair selection unit 86 then selects a lens distortion function pair (F, F⁻¹) corresponding to the angle of view θ from the profile database 40, and supplies the lens distortion correction function F to the lens distortion correction processing unit 88.

The lens distortion correction processing unit 88 corrects lens distortion occurring in the captured image by using the lens distortion function F⁻¹, and supplies the lens-distortion-corrected image to the perspective distortion function calculation unit 87. Using the lens-distortion-corrected image, the perspective distortion function calculation unit 87 calculates a perspective distortion function G which expresses the perspective distortion of the original image area 20 in the captured image, and then supplies the calculated perspective distortion function G to the perspective distortion correction processing unit 89.

The perspective distortion correction processing unit 89 corrects the perspective distortion of the original image area 20 by using the perspective distortion function G, and supplies the corrected original image area 20 to the watermark extraction unit 36.

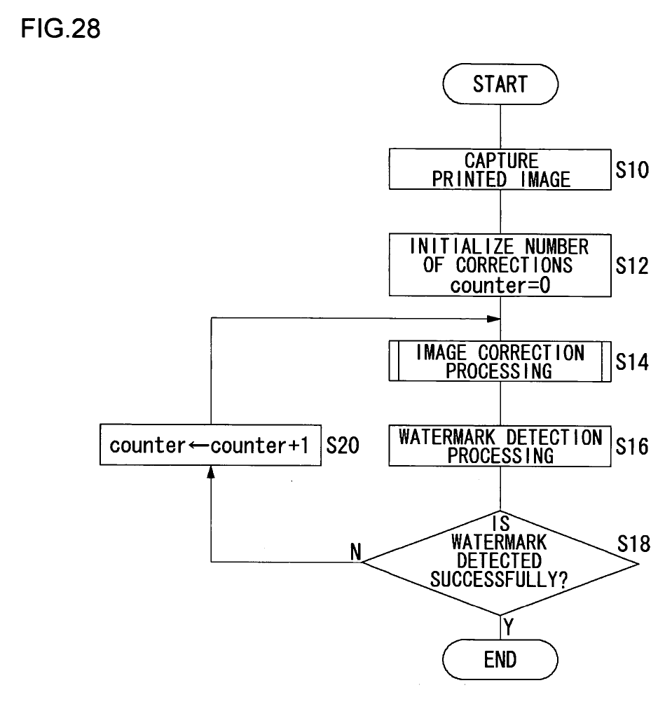

FIG. 28 is a flowchart showing the overall flow of the electronic watermark extraction steps. A difference from the electronic watermark extraction steps according to the first embodiment shown in FIG. 13 consists in that the image area determination processing S15 for extracting the original image area 20 is not included. In other respects, the steps are the same as in the first embodiment. According to the present embodiment, the original image area 20 is extracted while the perspective distortion is corrected in the image correction processing S14.

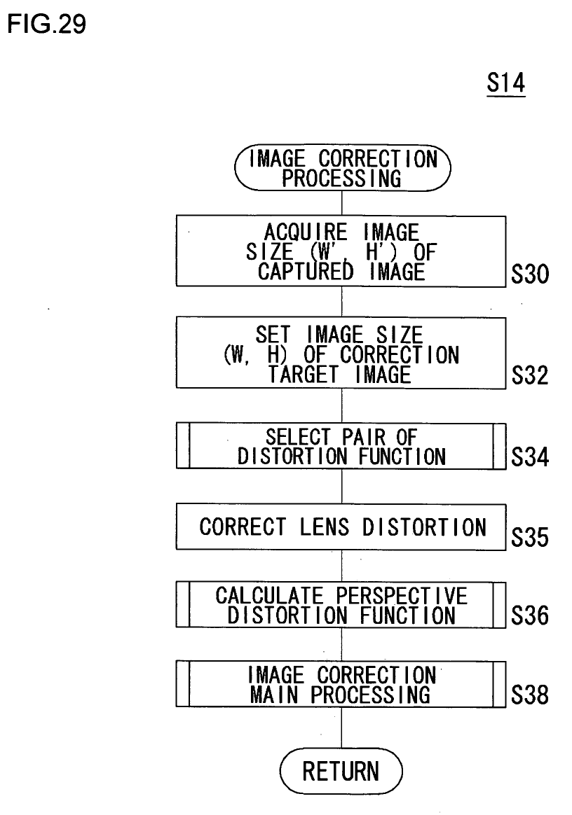

FIG. 29 is a flowchart for showing a general flow of the image correction processing S14 by the image correction unit 34 of the present embodiment. Differences from the image correction processing S14 of the first embodiment shown in FIG. 14 consist in that: the selection of a lens distortion function pair (S34) is followed by the correction of lens distortion (S35); after the lens distortion is corrected, a perspective distortion function is calculated further (S36); and in the image correction main processing S38, image correction is performed by using the perspective distortion function.

Description will now be given of the step for correcting lens distortion at S35. As in the procedure described in FIG. 16 of the first embodiment, the lens distortion correction processing unit 88 performs mapping by using the lens distortion function F⁻¹, thereby correcting the lens distortion occurring in the entire correction object image.

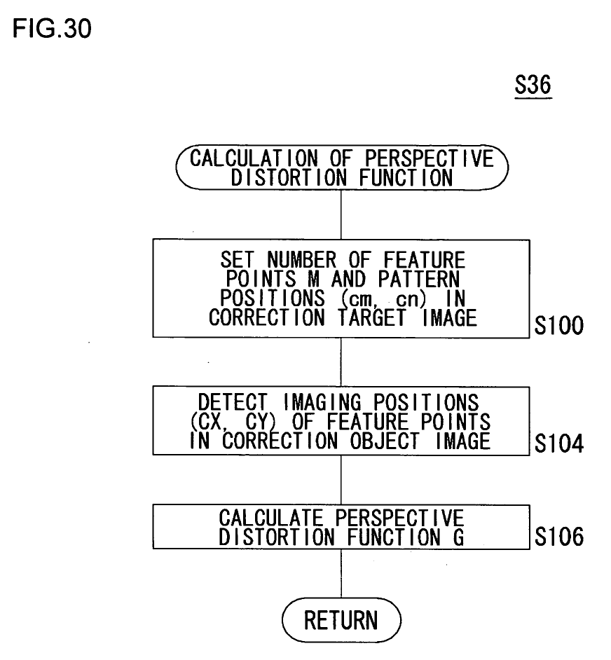

FIG. 30 is a flowchart showing the detailed steps for calculating a perspective distortion function at S36 of FIG. 29. Using the entire captured image of the printed image P as the correction object image, the image correction unit 34 sets the number of feature points M and pattern positions (cmₖ, cnₖ) (k=0, 1, . . . , M−1) of the same in the correction target image (S100). The positions of the feature points in the correction target image shall be known. For example, when vertexes at four corners of a rectangular correction target image are set as feature points, M=4 and the feature positions fall on (0, 0), (W−1, 0), (0, H−1), and (W−1, H−1). In another example, each side of a rectangular correction target image may be marked at regular intervals for feature points. Points on the edge of such an object as a personal figure in the correction target image may be used as the feature points.

Based on the information on the feature points set at step S100, the perspective distortion function calculation unit 87 performs processing for detecting corresponding feature points in the correction object image whose lens distortion is corrected. The perspective distortion function calculation unit 87 thereby determines the imaging positions (CXₖ, CYₖ) (k=0, 1, . . . , M−1) of the feature points in the correction object image (S104). Take, for example, the case of detecting vertexes at the four corners of the correction object image, or original image area 20, as feature points. Here, the vertexes of the original image area 20 are found by tracing the edges of the original image area 20 by using an edge filter or other techniques. Pixels near the vertexes are then Fourier-transformed to detect the phase angles for accurate positioning of the vertexes. When feature points consist of points on each side of the correction object image, the perspective distortion function calculation unit 87 performs processing for detection marks lying on the image frame of the original image area 20.

The perspective distortion function calculation unit 87 calculates a perspective distortion function G from the relationship between the feature points (CXₖ, CYₖ) detected at step S104 and the corresponding pattern positions (cmₖ, cnₖ) in the correction target image by using a least-square method (S106). This perspective distortion function G is calculated by the same steps as with the calculation of the perspective distortion function g at S208 of FIG. 10. That is, since the feature points (CXₖ, CYₖ) detected from the correction object image whose lens distortion is corrected are unaffected by lens distortion, deviations between the detected feature points (CXₖ, CYₖ) and the corresponding pattern positions (cmₖ, cnₖ) of the correction target image are ascribable to perspective distortion. The relationship therebetween thus satisfies the equations of the perspective distortion described in the calculation of the perspective distortion function g at S208 of FIG. 10. By determining the coefficients of these perspective distortion equations, the perspective distortion function calculation unit 87 can calculate the perspective distortion function G.

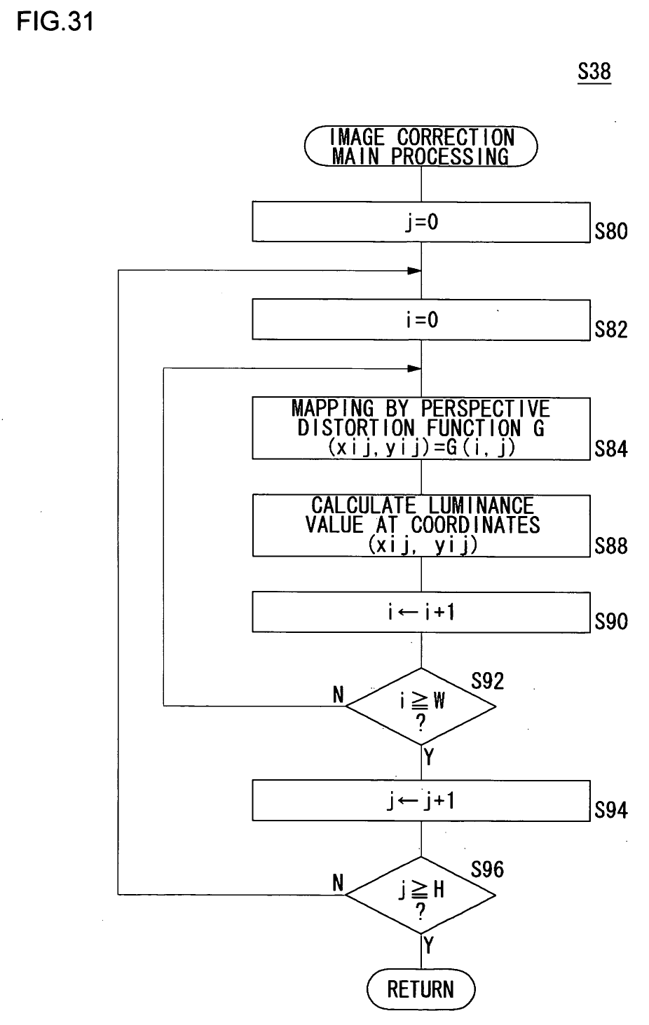

FIG. 31 is a flowchart showing the detailed steps of the image correction main processing S38 according to the present embodiment. The perspective distortion correction processing unit 89 initializes the y-coordinate value j of the correction target image to 0 (S80). Next, it initializes the x-coordinate value i of the correction target image to 0 (S82).

The perspective distortion correction processing unit 89 maps a point P(i, j) of the correction target image by using the perspective distortion function G (S84). The point mapped by the perspective distortion function G will be denoted as Q(xᵢⱼ, yᵢⱼ):
(xᵢⱼ, yᵢⱼ)=G(i, j)

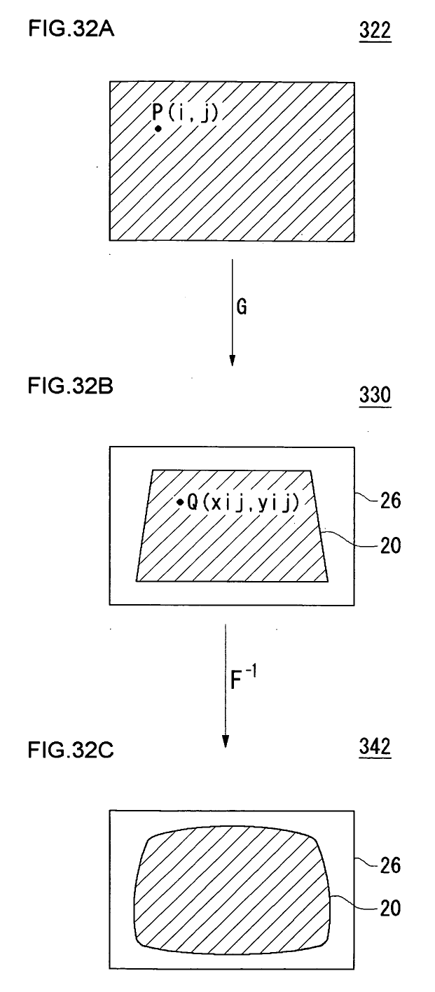

FIGS. 32A to 32C are diagrams for explaining how a point in a correction target image is mapped onto a point in a correction object image. FIG. 32A shows a correction target image 322 which corresponds to the original image area 20 in the captured image. The correction target image 322 has a size of W in width and H in height. FIG. 32C shows a correction object image 342 which is a captured image having both lens distortion and perspective distortion. The entire captured area 26, including the original image area 20, is lens- and perspective-distorted. At step S35 of FIG. 29, the lens distortion correction processing unit 88 corrects the lens distortion of the correction object image 342 of FIG. 32C by using the lens distortion function F⁻¹. This transforms the correction object image 324 into a lens-distortion-corrected image 330 of FIG. 32B. In the lens-distortion-corrected image 330, the lens distortion of the entire captured area 26 including the original image area 20 is eliminated, whereas the perspective distortion still remains.

At step S84 of FIG. 31, the point P(i, j) in the correction target image 322 is mapped onto the point Q(xᵢⱼ, yᵢⱼ) in the lens-distortion-corrected image 330 which has the perspective distortion, by using the perspective distortion function G as shown in FIG. 32.

The perspective distortion correction unit 89 calculates the luminance value L(xᵢⱼ, yᵢⱼ) at the point Q(xᵢⱼ, yᵢⱼ) by interpolating the luminance values of peripheral pixels by a bi-linear interpolation method or the like. The luminance value L(xᵢⱼ, yᵢⱼ) calculated is set as the luminance value at the point P(i, j) of the correction target image (S88).

The x-coordinate value i is incremented by one (S90). If the x-coordinate value i is smaller than the width W of the correction target image (N at S92), the processing returns to step S84. The processing for determining the luminance value of a pixel is thus repeated while increasing the coordinate value in the x-axis direction.

If the x-coordinate value i reaches or exceeds the width W of the correction target image (Y at S92), it means that the luminance values of the pixels at the current y-coordinate value j are obtained through the x-axis direction. The y-coordinate value j is then incremented by one (S94). If the y-coordinate value j reaches or exceeds the height H of the correction target image (Y at S96), the processing ends since the luminance values are obtained of all the pixels of the correction target image. If the y-coordinate value j is smaller than the height H of the correction target image (N at S96), the processing returns to step S82. The x-coordinate value is initialized to zero again, and the processing for determining the luminance value of a pixel is repeated while the coordinate value is increased in the x-axis direction under the new y-coordinate value j.

As described above, the electronic watermark extracting apparatus 200 according to the present embodiment can utilize lens distortion correction functions to detect the position deviations of feature points ascribable to perspective distortion, and determine the perspective distortion function accurately upon each capturing. Consequently, even when an image has perspective distortion aside from lens distortion, the lens distortion and the perspective distortion can be processed separately for accurate distortion correction.

Up to this point, the present invention has been described in conjunction with an embodiment thereof. The foregoing embodiment has been given solely by way of illustration. It will be understood by those skilled in the art that various modifications may be made to combinations of the foregoing components and processes, and all such modifications are also intended to fall within the scope of the present invention.

The foregoing embodiment has deal with the case where a perspective distortion function is calculated for the purpose of correcting perspective distortion. Instead, in one modification, profile data on lattice configurations that show several patterns of perspective distortion may be stored in the profile database 40 in advance. For example, when capturing the lattice pattern image R, the optical axis is tilted in various directions and angles so that a plurality of lattice patterns having perspective distortion are captured and stored in the profile database 40 in advance. Then, during image correction, perspective distortion is corrected by using the most suitable one of the lattice patterns.

The foregoing description has dealt with the case where the lens distortion function pairs are registered in the profile database 40. Nevertheless, the correspondence between the points in the correction target image and the points in the correction object image may be stored in the profile database 40 in the form of tables, not functions. In this case, the correction target image may be sectioned into lattices according to the size of the embedded blocks of the watermark. The correspondence between the lattice points alone is then stored into the profile database 40 as profile data on lens distortion.

In the foregoing steps of detecting a watermark, if watermark detection fails, the threshold and other parameters are adjusted and the image correction processing is repeated to retry the watermark detection. Nevertheless, if watermark detection fails or if the number of corrections exceeds a predetermined number, the image correction unit 34 may request the capturing unit 30 to capture the printed image P again.

The data on the lens distortion function pairs may be stored in the profile database 40 as classified by the models of capturing devices including digital cameras and scanners. The electronic watermark extracting apparatus 200 may acquire model information on the capturing device, and select and use the data on lens distortion function pairs suited to the model that is used when capturing the printed image P.

The foregoing embodiment has dealt with the case where image correction is performed on the original image area 20 of an image in which an electronic watermark is embedded by the “block embedding method.” Nevertheless, this is just an example of embodiment of the image correction technology of the present invention. According to the configuration and processing steps described in the foregoing embodiment, it is possible to correct images in which electronic watermarks are embedded by other methods. Moreover, according to the configurations and processing steps of image correction described in the foregoing embodiment, it is possible to correct ordinary images having no electronic watermark embedded therein. For example, the image correction technology of the present invention is not limited to the correction of captured images of printed images, but may also be applied to the correction of images obtained by photographing actual subjects such as a personal figure and a landscape with a camera.

### Third Embodiment

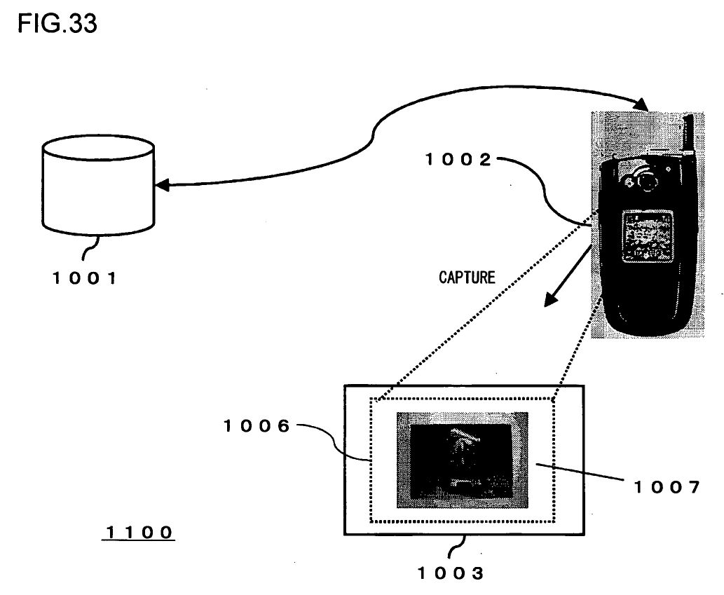

FIG. 33 is a block diagram of an image data provision system 1100 to which the present invention is applied. This image data provision system 1100 is intended to provide two-dimensional images of a product (here, digital camera), or a three-dimensional object, taken from various points of view to clients.

The product image data provision system 1100 comprises a server 1001, a camera-equipped cellular phone 1002, and a printed material 1003. A watermarked product image 1007 is printed on the printed material 1003.

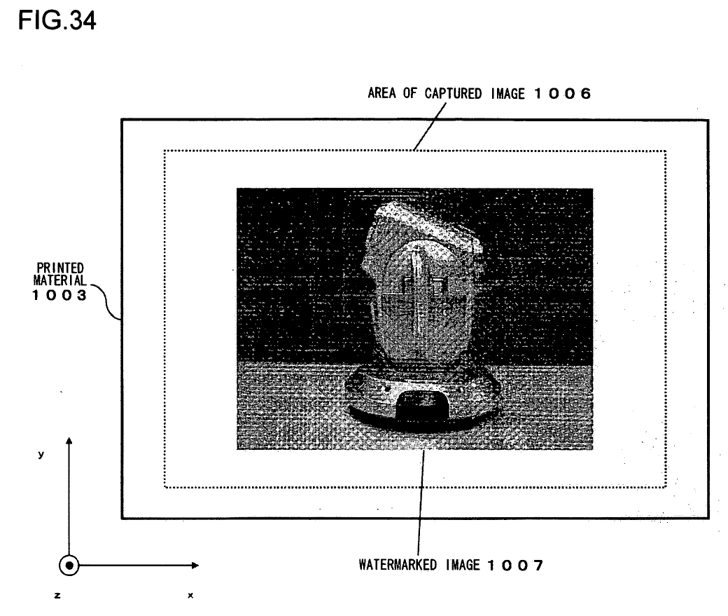

FIG. 34 shows a conceptual rendering of the watermarked product image 1007. This watermarked product image 1007 is a side view of the product (here, digital camera), a three-dimensional object. Identification information corresponding to the product is embedded in this image in the form of an electronic watermark.

In the following description of the present embodiment, as shown in the diagram, the horizontal direction of the watermarked product image 1007 will be referred to as x direction and the vertical direction of the watermarked product image 1007 as y direction. The direction perpendicular to the watermarked product image 1007, piercing the image from the back to the front, will be referred to as z direction.

A client captures the watermarked product image 1007 with the camera (camera-equipped cellular phone 1002) tilted according to the desired point of view of a two-dimensional image of the product. The digital image data obtained by this capturing is transmitted to the server 1001.

Receiving this image data, the server 1001 corrects perspective distortion that occurs in the image data since the camera is tilted by the client when capturing. Next, the information embedded by the electronic watermark technology is detected from the corrected image data. Based on the information embedded by the electronic watermark technology and perspective distortion information obtained during correction, two-dimensional image data on the corresponding product, taken from a point of view (such as obliquely above and obliquely sideways), is selected from an image database of the server 1001. The two-dimensional image data selected from the image database is returned to the camera-equipped cellular phone 1002.

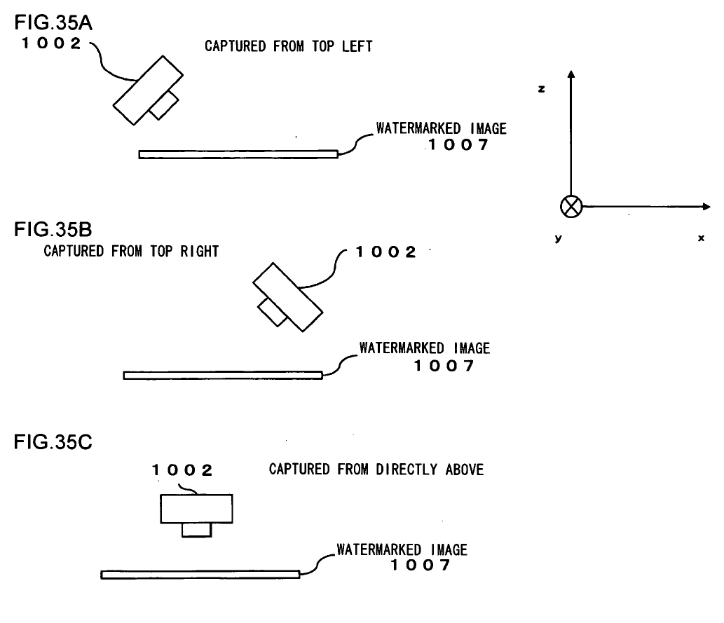

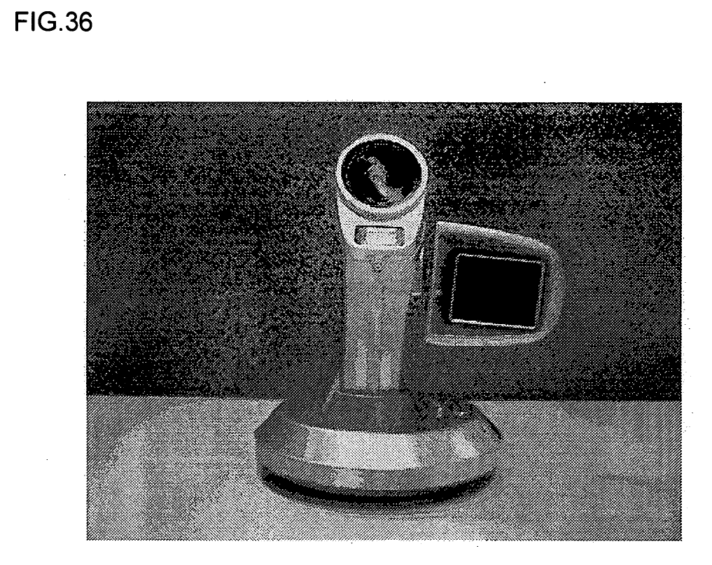

For example, as shown in FIG. 35A, when the client captures the watermarked product image 1007 from top left (“+z, −x” side), the server 1001 transmits two-dimensional image data of the product as viewed from the front (FIG. 36) to the camera-equipped cellular phone 1002 of the client.

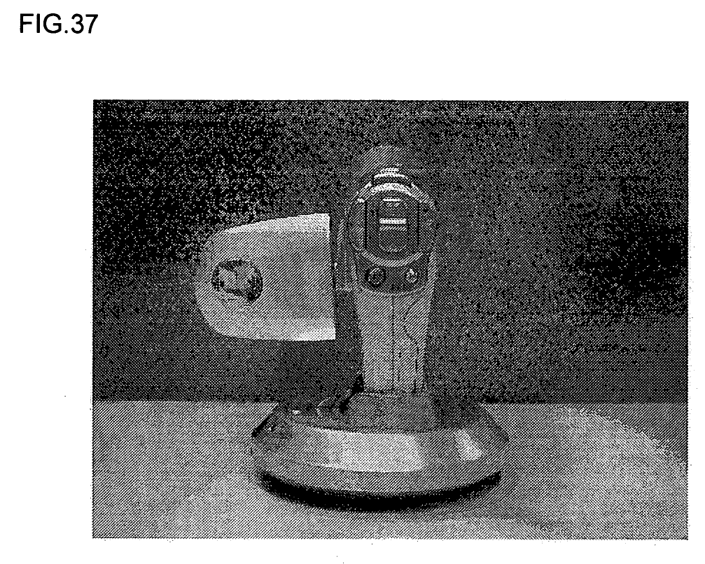

When the client captures the watermarked product image 1007 from top right (“+z, +x” side) as shown in FIG. 35B, the server 1001 transmits two-dimensional image data of the product as viewed from behind (FIG. 37) to the camera-equipped cellular phone 1002 of the client.

When the client captures the watermarked product image 1007 from directly above (“+z” side) as shown in FIG. 35C, the server 1001 transmits high-resolution two-dimensional image data of the product as viewed sideways (not shown) to the camera-equipped cellular phone 1002 of the client.

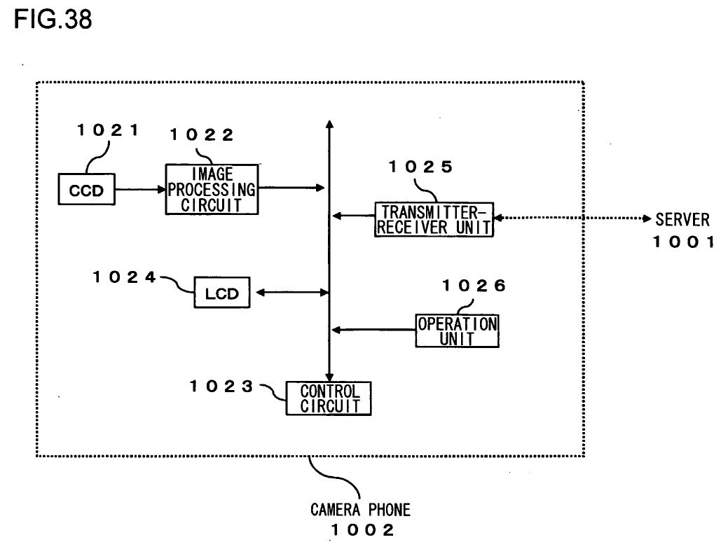

FIG. 38 is a block diagram of the camera-equipped cellular phone 1002 according to the present embodiment. The camera-equipped cellular phone 1002 includes a CCD 1021, an image processing circuit 1022, a control circuit 1023, an LCD 1024, a transmitter-receiver unit 1025, an operation unit 1026, etc. It should be noted that the diagram shows only those components of the camera-equipped cellular phone 1002 that are necessary for camera facilities and communications with the server 1001. The rest of the configuration is omitted from the diagram.

Imaging data on a captured image 1006 (see FIG. 34) captured by the CCD 1021 is digitally converted into digital image data by the image processing circuit 1022.

The transmitter-receiver unit 1025 performs data communication processing with exterior. Specifically, it transmits the digital image data to the server 1001 and receives data transmitted from the server 1001.

The LCD 1024 displays the digital image data and data transmitted from exterior.

The operation unit 1026 has buttons for making a call, as well as a shutter button and the like necessary for capturing.

The image processing circuit 1022, the LCD 1024, the transmitter-receiver unit 1025, and the operation unit 1026 are connected with the control circuit 1023.

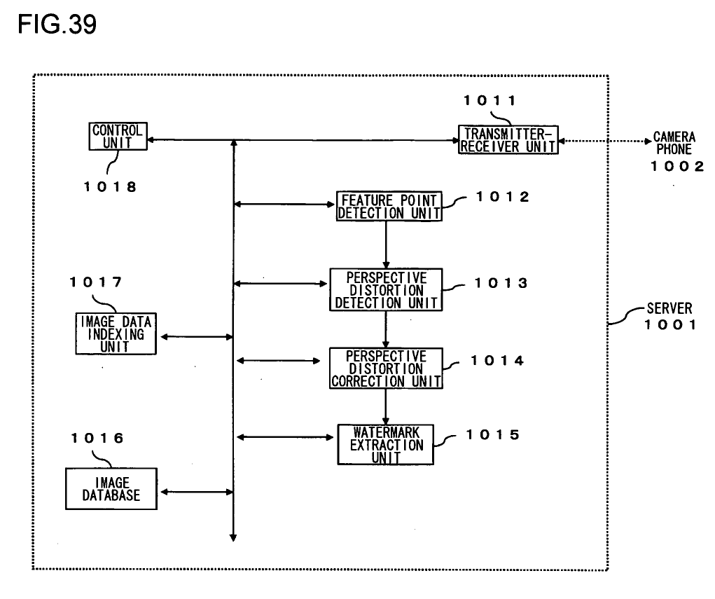

FIG. 39 is a block diagram of the server 1001 according to the present embodiment. The server 1001 comprises such components as a transmitter-receiver unit 1011, a feature point detection unit 1012, a perspective distortion detection unit 1013, a perspective distortion correction unit 1014, a watermark extraction unit 1015, an image database 1016, an image data indexing unit 1017, and a control unit 1018.

The transmitter-receiver unit 1011 performs transmission and reception processing with exterior. Specifically, it receives digital image data transmitted from the camera-equipped cellular phone 1002, and transmits information data to the camera-equipped cellular phone 1002.

The feature point detection unit 1012 performs processing for detecting feature points from the digital image data received by the transmitter-receiver unit 1011. Here, the feature points are ones intended for cutting out the area of the watermarked product image 1007 (for example, four feature points lying at the four corners of the frame of the watermarked product image 1007). The method for detecting these feature points is described, for example, in the specification of a patent application filed by the applicant (Japanese Patent Application No. 2003-418272).

The feature point detection unit 1012 also performs image decoding processing, if necessary, before the feature point detection processing. For example, when the digital image data is JPEG image data, the feature point detection processing must be preceded by decoding processing for converting the JPEG image data into a two-dimensional array of data that expresses level values at respective coordinates.

The perspective distortion detection unit 1013 detects perspective distortion from the digital image data transmitted from the camera-equipped cellular phone 1002. Then, based on this perspective distortion, it estimates the capturing direction in which the image is captured by the camera-equipped cellular phone 1002. Now, the method of estimating the capturing direction will be described below.

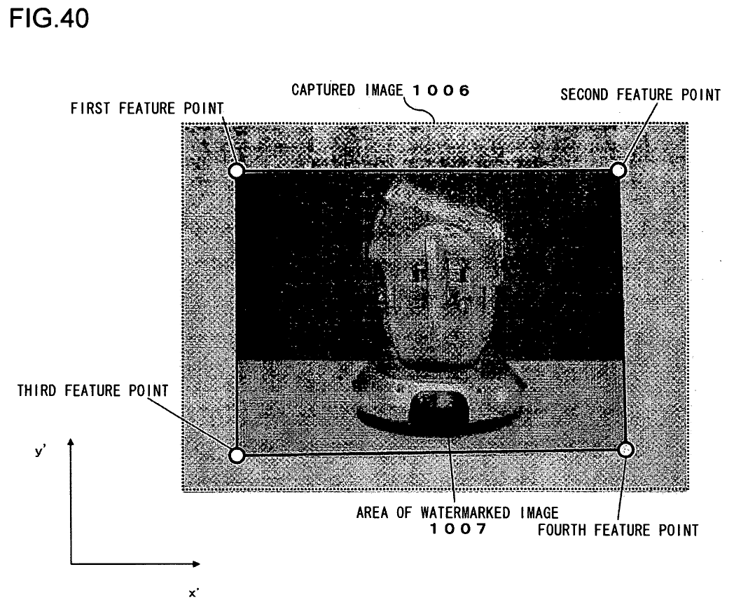

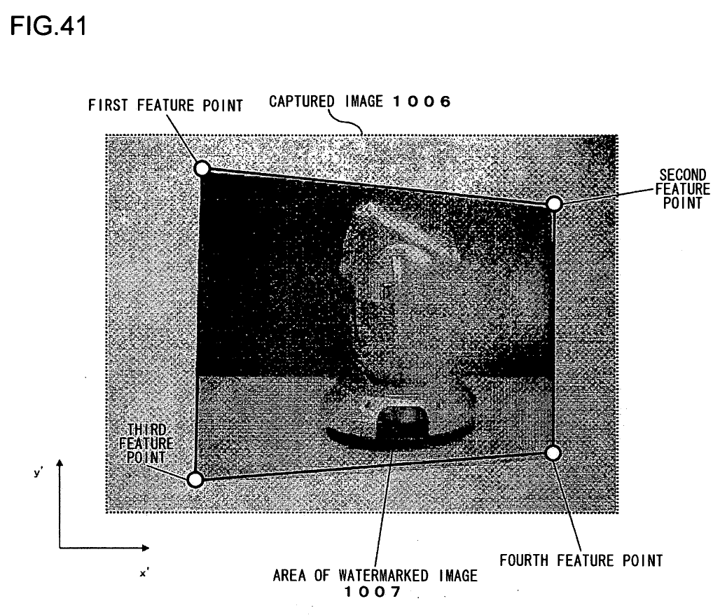

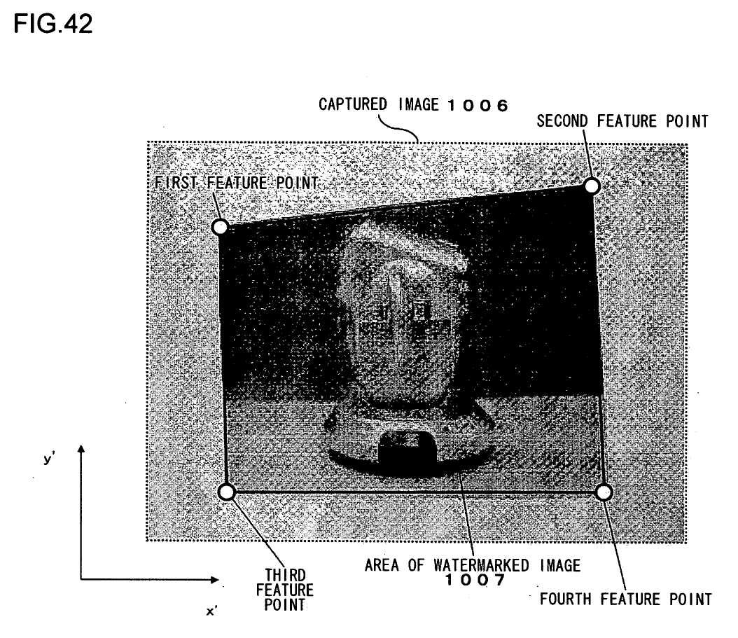

FIG. 40 shows a captured image 1006 of the watermarked product image 1007 when captured from directly above (the “+z” side of FIG. 34). FIG. 41 shows the captured image 1006 of the watermarked product image 1007 when captured from top left (the “+z, −x” side of FIG. 34). FIG. 42 shows the captured image 1006 of the watermarked product image 1007 when captured from top right (the “+z, +x” side of FIG. 34). In FIGS. 40 to 42, the horizontal direction of the captured image 1006 will be referred to as x′ direction, and the vertical direction as y′ direction.

Referring to FIG. 40 (or FIG. 41, FIG. 42), the capturing direction is detected based on the relationship between a distance d₁₃ and a distance d₂₄. Here, d₁₃ is the distance between a first feature point which falls on the top left corner (“−x′, +y′” side) of the area of the watermarked product image 1007 and a third feature point which falls on the bottom left (“−x′, −y′” side) of the same. Then, d₂₄ is the distance between a second feature point which falls on the top right corner (“+x′, +y′” side) of the area of the watermarked product image 1007 and a fourth feature point which falls on the bottom right corner (“+x′, −y′” side) of the same.

Referring to FIG. 40, when the watermarked product image 1007 is captured from directly above, d₁₃=d₂₄. Thus, if the distances between the feature points detected by the feature point detection unit 1012 have the relationship d₁₃=d₂₄, the perspective distortion detection unit 1013 recognizes that the captured image 1006 is one obtained when the watermarked product image 1007 is captured from directly above (the “+z” side of FIG. 34).

Referring to FIG. 41, when the watermarked product image 1007 is captured from top left, d₁₃>d₂₄. Thus, if the distances between the feature points detected by the feature point detection unit 1012 have the relationship d₁₃>d₂₄, the perspective distortion detection unit 1013 recognizes that the captured image 1006 is one obtained when the watermarked product image 1007 is captured from top left (the “+z, −x” side of FIG. 34).

Referring to FIG. 42, when the watermarked product image 1007 is captured from top right, d₁₃<d₂₄. Thus, if the distances between the feature points detected by the feature point detection unit 1012 have the relationship d₁₃<d₂₄, the perspective distortion detection unit 1013 recognizes that the captured image 1006 is one obtained when the watermarked product image 1007 is captured from top right (the “+z, +x” side of FIG. 34).

It should be appreciated that the perspective distortion detection unit 1013 need not necessarily make determinations as mentioned above, or:

if d₁₃=d₂₄, the image is captured from above;

if d₁₃<d₂₄, the image is captured from top right; and

if d₁₃>d₂₄, the image is captured from top left.

Instead, the perspective distortion detection unit 1013 may assume a certain positive value a and make determinations as follows:

if |d₁₃−d₂₄|<α, the image is captured from above;

if d₂₄−d₁₃≧α, the image is captured from top right; and

if d₁₃−d₂₄≧α, the image is captured from top left.

Here, α is a parameter for allowing deviations in perspective distortion occurring at the time of capturing.

The perspective distortion detection unit 1013 may also assume a certain positive value β (where β>α), so that
if |d₁₃−d₂₄|>β,
it aborts the subsequent processing of the digital image data, determining that the subsequent correction of the perspective distortion or the detection of a watermark is impossible.

The perspective distortion correction unit 1014 corrects the perspective distortion of the digital image data detected by the perspective distortion detection unit 1013. The method of correcting perspective distortion is described, for example, in the specification of a patent application filed by the applicant (Japanese Patent Application No. 2003-397502).

From the digital image data whose perspective distortion is corrected by the perspective distortion correction unit 1014, the watermark extraction unit 1015 extracts information embedded by the electronic watermark technology. The method of extracting this electronic watermark information is described, for example, in the publication of an unexamined patent application filed by the applicant (Japanese Patent Laid-Open Publication No. 2003-244419).

The image database 1016 contains two-dimensional image data obtained by capturing a variety of products, or three-dimensional objects, from various angles.

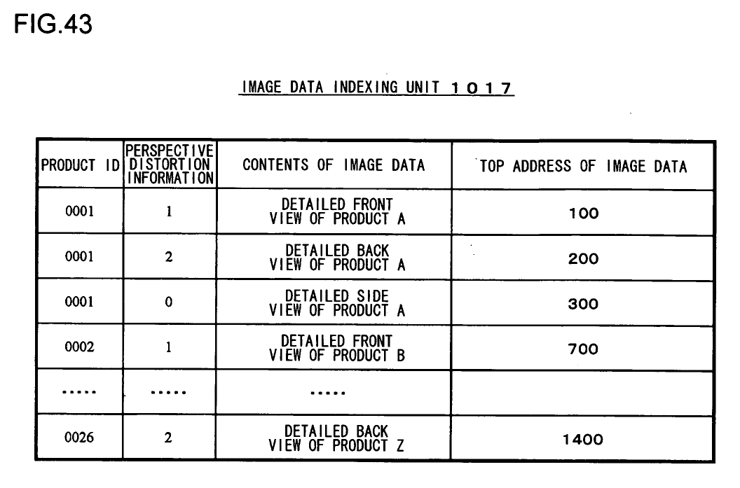

The image data indexing unit 1017 contains index information on the two-dimensional image data stored in the image database 1016. More specifically, referring to FIG. 43, the image data indexing unit 1017 contains information on the contents of the two-dimensional image data and information on the top addresses of the two-dimensional image data in the image database 1016, with product ID indicating the product model/model number and perspective distortion information as two index keys. The product ID corresponds to the electronic watermark information embedded in digital image data, extracted from the digital image data by the watermark extraction unit 1015. The information on the top addresses is used to index the images. Any information may be used as long as the images can be identified uniquely.

The perspective distortion information corresponds to the perspective distortion detected by the perspective distortion detection unit 1013, i.e., the capturing direction at the time of capturing by the client. When the client captures the watermarked product image 1007 from directly above, the perspective distortion information will be “0.” When the client captures the watermarked product image 1007 from top left, the perspective distortion information will be “1.”

When the client captures the watermarked product image 1007 from top right, the perspective distortion information will be “2.”

The control unit 1018 controls the components of the server 1001.

It should be noted that in terms of hardware, these components can be achieved by an arbitrary computer CPU, a memory, and other LSIs. In terms of software, they can be achieved by programs or the like that are loaded on a memory and have the functions for processing images and embedding electronic watermarks. The functional blocks shown here are achieved by the cooperation of these. It will thus be understood by those skilled in the art that these functional blocks may be achieved in various forms including hardware alone, software alone, and a combination of these.

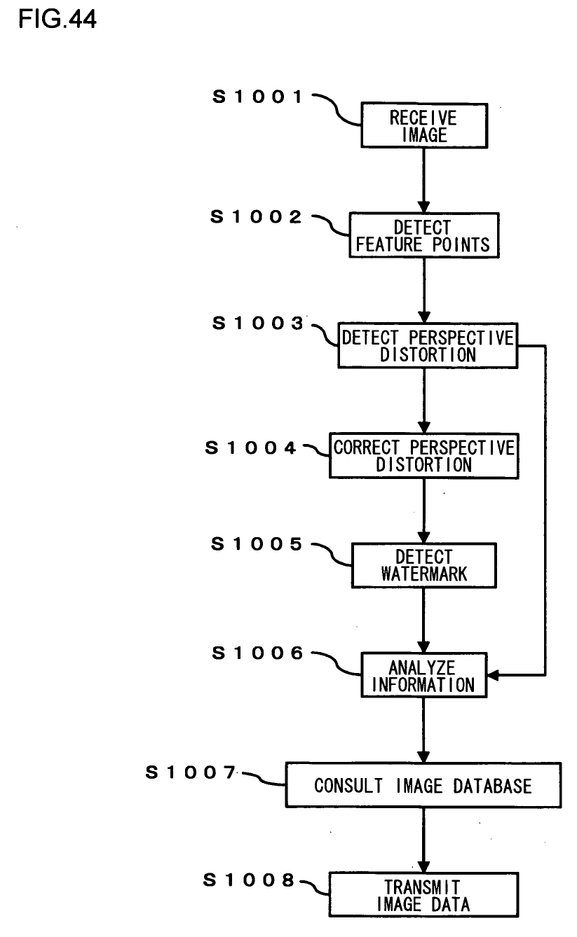

FIG. 44 is a flowchart showing the processing of the server 1001 according to the present embodiment.

At step S1001, the transmitter-receiver unit 1011 receives digital image data transmitted from the camera-equipped cellular phone 1002. At step S1002, the feature point detection unit 1012 performs processing for detecting feature points intended for cutting out the area of the watermarked product image 1007 (for example, four feature points lying at the four corners of the frame of the watermarked product image 1007) from the digital image data received by the transmitter-receiver unit 1011. If necessary, the feature point detection unit 1012 performs image decoding processing before the feature point detection processing.

At step S1003, the perspective distortion detection unit 1013 detects perspective distortion of the digital image data transmitted from the camera-equipped cellular phone 1002. The method of detecting the perspective distortion is as described above.

At step S1004, the perspective distortion correction unit 1014 corrects the perspective distortion detected by the perspective distortion detection unit 1013.

At step 1005, the watermark extraction unit 1015 extracts information embedded by the electronic watermark technology, from the digital image data whose perspective distortion is corrected by the perspective distortion correction unit 1014.

At step S1006, the image data indexing unit 1017 is consulted with the information extracted by the watermark extraction unit 1015 and the perspective distortion information detected by the perspective distortion detection unit 1013 as index keys. In consequence, the type of two-dimensional image data requested by the user is identified.

At step S1007, the image database 1016 is consulted to acquire the two-dimensional image data identified at the foregoing step S1006.

At step S1008, the transmitter-receiver unit 1011 performs the processing of transmitting the two-dimensional image data acquired from the image database 1016 to the camera-equipped cellular phone 1002.

According to the present embodiment, the client can transfer a plurality of pieces of information (the product to view and the desired point of view) to the server of the image database by a single capturing operation. Conventionally, the client had to select the desired point of view by pressing a button down after capturing the watermarked image of the product to view. Otherwise, the administrator of the image database had to provide a number of watermarked images corresponding to the combinations of products and the points of view.

According to the present embodiment, it is therefore possible to reduce the operation burden on the client and improve the economic efficiency for the administrator of the image database as well.

### Modification 1 of Third Embodiment

The third embodiment has dealt with the case where the watermarked product image 1007 is captured with the camera tilted according to the desired point of view of the two-dimensional image of the product, a three-dimensional object. The capturing directions, however, are not limited to the three directions in the foregoing example.

Suppose, for example, that the client wants to view an image of the product taken from the top (the ceiling side). Then, the client can acquire the image taken from the ceiling side from the server 1001 by capturing the watermarked product image 1007 from the “+z, +y” side of FIG. 34.

Suppose also that the client wants to view an image of the product taken from the bottom (the floor side). Then, the client can acquire the image taken from the floor side from the server 1001 by capturing the watermarked product image 1007 from the “+z, −y” side.

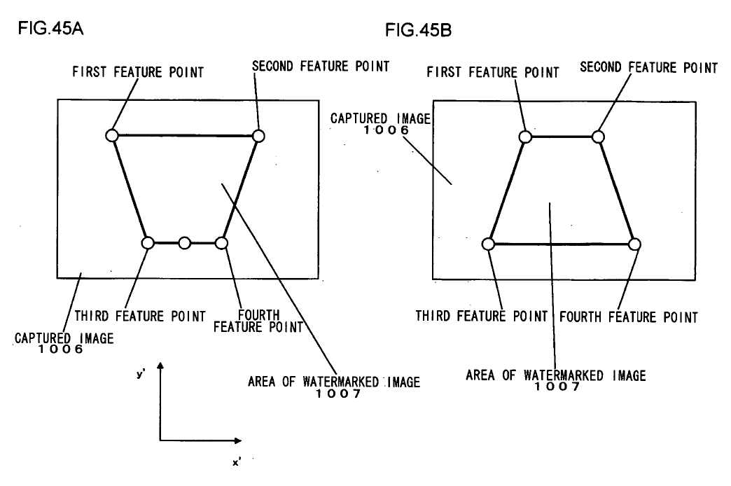

In such cases, referring to FIGS. 45A and 45B, the capturing direction is detected based on the relationship between a distance d₁₂ and a distance d₃₄. Here, d₁₂ is the distance between the first feature point which falls on the top left corner (“−x′, +y′” side) of the area of the watermarked product image 1007 and the second feature point which falls on the top right corner (“+x′, +y′” side) of the same. Then, d₃₄ is the distance between the third feature point which falls on the bottom left corner (“−x′, −y′” side) of the area of the watermarked product image 1007 and the fourth feature point which falls on the bottom right corner (“+x′, −y′” side) of the same.

More specifically:

i) if d₁₂>d₃₄, the server 1001 recognizes that the image is captured from the “+z, +y” side, and that the client wants the image of the product taken from the top (the ceiling side); and

ii) if d₁₂<d₃₄, the server 1001 recognizes that the image is captured from the “+z, −y” side, and that the client wants the image of the product taken from the bottom (the floor side).

### Modification 2 of Third Embodiment

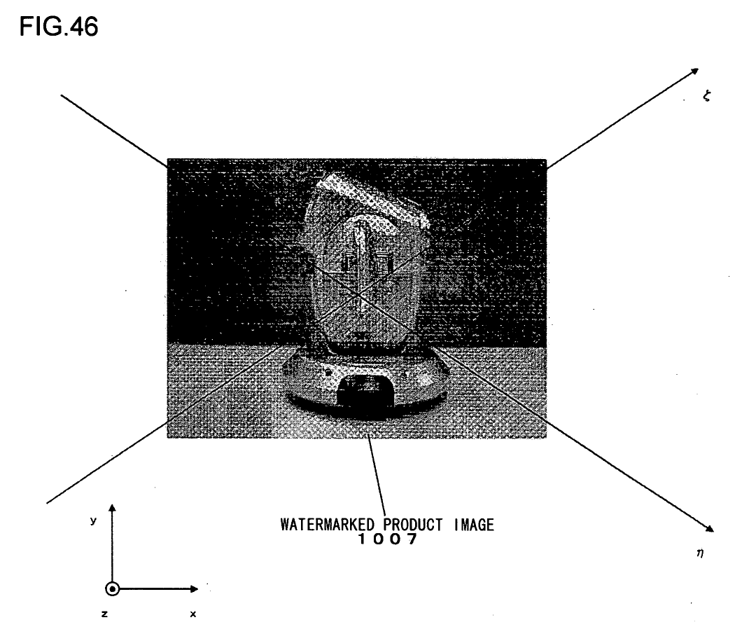

As shown in FIG. 46, the two diagonals of the watermarked product image 1007 will now be referred to as ζ-axis and η-axis, respectively. If the client wants an image of the rear of the product as viewed from the ceiling side, he/she can capture the watermarked product image 1007 from the “+z, +ζ” side to obtain the corresponding image. If the client wants an image of the rear of the product as viewed from the floor side, he/she can capture the watermarked product image 1007 from the “+z, +η” side to obtain the corresponding image.

In such cases:

iii) if d₁₂>d₃₄ and d₁₃<d₂₄, the server 1001 recognizes that the image is captured from the “+z, +ζ” side; and

iv) if d₁₂<d₃₄ and d₁₃<d₂₄, the server 1001 recognizes that the image is captured from the “+z, +η” side.

### Modification 3 of Third Embodiment

The foregoing examples have dealt with a system for providing images of a digital camera, a three-dimensional object, taken from respective points of view to clients. Nevertheless, the present invention may also be applied to a system for providing images of a passenger vehicle, a three-dimensional object, taken from respective points of view to clients.

### Experomental Example of Third Embodiment

A system having the same configuration as that of the image data provision system 1100 described in the third embodiment was constructed and subjected to an experiment. In this experiment, the diagonal length of a subject image (corresponding to the watermarked product image 1007 of the third embodiment) was 70.0 mm, the diagonal length of the CCD was 8.86 mm ( 1/1.8 inch), the focal length of the camera lens was 7.7 mm, and the distance from the subject to the lens center was set to range from 70 to 100 mm.

As a result, even if the subject image was captured with perspective distortion, it was possible to correct the perspective distortion and extract the information embedded by the electronic watermark technology unless the angle formed between the normal to the subject image and the optical axis of the camera exceeded 20°.

The present invention would have poor practicability if information embedded by the electronic watermark technology could not be extracted from images that were captured at angles considerably off from directly above. In fact, as shown from the foregoing experimental result, the information embedded by the electronic watermark technology can be extracted even when the images are captured at angles off from directly above as largely as 20°. The present invention thus has high practicability.

In this experiment, the testing system was set to make the following determinations: if the angle formed between the normal to the subject image and the optical axis of the camera was below 5°, the subject image was captured from directly above; and if the angle formed between the normal to the subject image and the optical axis of the camera reaches or exceeds 5°, the subject image was captured obliquely . In this experiment, misrecognition of the capturing direction was not observed at all.

### Fourth Embodiment

The third embodiment has dealt with the case where the perspective distortion of the digital image transmitted from the camera-equipped cellular phone 1002 is detected and corrected by the server 1001.

In the present embodiment, on the other hand, the camera-equipped cellular phone 1002 performs perspective distortion detection and correction before transmitting digital image data to the server 1001. The information on the perspective distortion detected is stored in a header area of the digital image data. The data area of the digital image data contains the image data whose perspective distortion is corrected.

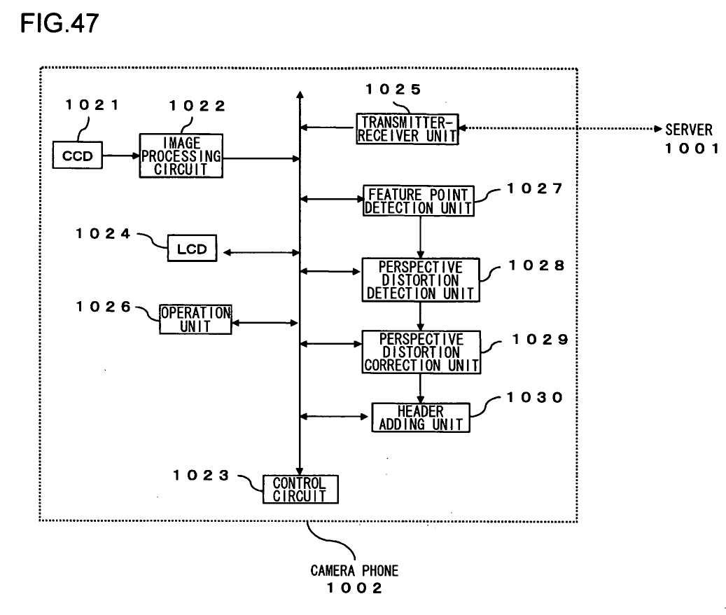

FIG. 47 is a block diagram of the camera-equipped cellular phone 1002 according to the present embodiment.

The camera-equipped cellular phone 1002 includes a CCD 1021, an image processing circuit 1022, a control circuit 1023, an LCD 1024, a transmitter-receiver unit 1025, an operation unit 1026, a feature point detection unit 1027, a perspective distortion detection unit 1028, a perspective distortion correction unit 1029, a header adding unit 1030, etc. It should be noted that the diagram shows only those components of the camera-equipped cellular phone 1002 that are necessary for camera facilities, perspective distortion correcting functions, and communications with the server 1001. The rest of the configuration is omitted from the diagram.

The CCD 1021, the image processing circuit 1022, the control circuit 1023, the LCD 1024, and the operation unit 1026 are the same as those of the camera-equipped cellular phone 1002 according to the third embodiment. Detailed description thereof will thus be omitted.

The feature point detection unit 1027 performs processing for detecting feature points of the area of the watermarked product image 1007 from the digital image data generated by the image processing circuit 1022. As employed here, the feature points shall refer to four feature points lying at the four corners of the frame of the watermarked product image 1007.

The perspective distortion detection unit 1028 detects perspective distortion of the digital image data. The method of detecting the perspective distortion is the same as with the perspective distortion detection unit 1013 of the server 1001 according to the third embodiment. Detailed description will thus be omitted.

The perspective distortion correction unit 1029 corrects the perspective distortion detected by the perspective distortion detection unit 1028. As with the perspective distortion correction unit 1014 of the server 1001 according to the third embodiment, the examples of the correction method include the technology described in the specification of Japanese Patent Application No. 2003-397502.

The header adding unit 1030 adds the information on the perspective distortion detected by the perspective distortion detection unit 1028 to the header area of the digital image data.

The digital image data accompanied with the information on the perspective distortion is transmitted from the transmitter-receiver unit 22 to the server 1001.

It should be appreciated that the information on the perspective distortion detected by the perspective distortion detection unit 1028 may be displayed on the LCD 1024. This makes it possible for the client to check if his/her own choice is reflected on his/her capturing operation before transmitting the digital image data to the server 1001.

It should be noted that in terms of hardware, these components can be achieved by an arbitrary computer CPU, a memory, and other LSIs. In terms of software, they can be achieved by programs or the like that are loaded on a memory and have the functions for processing images and embedding electronic watermarks. The functional blocks shown here are achieved by the cooperation of these. It will thus be understood by those skilled in the art that these functional blocks may be achieved in various forms including hardware alone, software alone, and a combination of these.

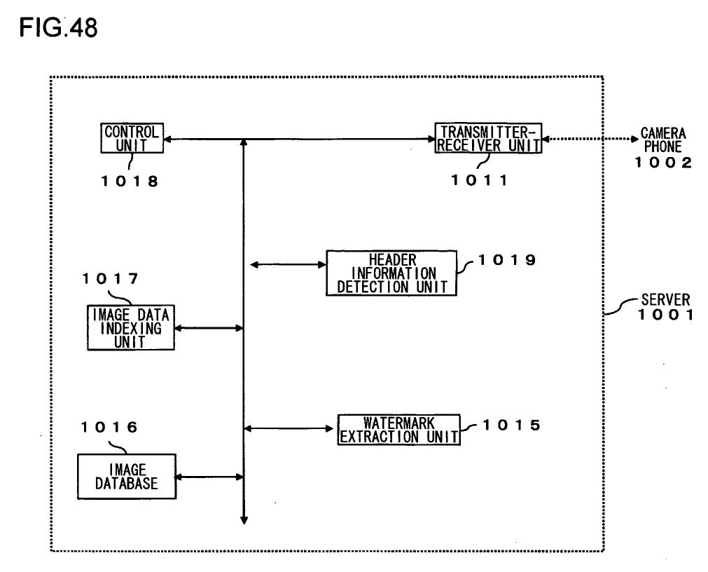

FIG. 48 is a block diagram of the server 1001 according to the present embodiment. The server 1001 includes a transmitter-receiver unit 1011, a watermark extraction unit 1015, an image database 1016, an image data indexing unit 1017, a control unit 1018,a header information detection unit 1019, etc.

As in the server 1001 of the third embodiment, the transmitter-receiver unit 1011 performs data transmission and reception processing.

The watermark extraction unit 1015 extracts information embedded by the electronic watermark technology from digital image data received by the transmitter-receiver unit 1011.

The header information detection unit 1019 detects perspective distortion information stored in the header area of the digital image data transmitted from the camera-equipped cellular phone 1002.

As in the server 1001 of the third embodiment, the image database 1016 contains two-dimensional image data obtained by capturing a variety of products, or three-dimensional objects, from various angles.

The image data indexing unit 1017 also contains index data on the two-dimensional image data stored in the image database 1016 as in the server 1001 of the third embodiment (see FIG. 43). Nevertheless, a difference from the server 1001 of the third embodiment lies in that the perspective distortion information, an index key, is detected by the header information detection unit 1019.

It should be noted that in terms of hardware, these components can also be achieved by an arbitrary computer CPU, a memory, and other LSIs. In terms of software, they can be achieved by programs or the like that are loaded on a memory and have the functions for processing images and embedding electronic watermarks. The functional blocks shown here are achieved by the cooperation of these. It will thus be understood by those skilled in the art that these functional blocks may be achieved in various forms including hardware alone, software alone, and a combination of these.

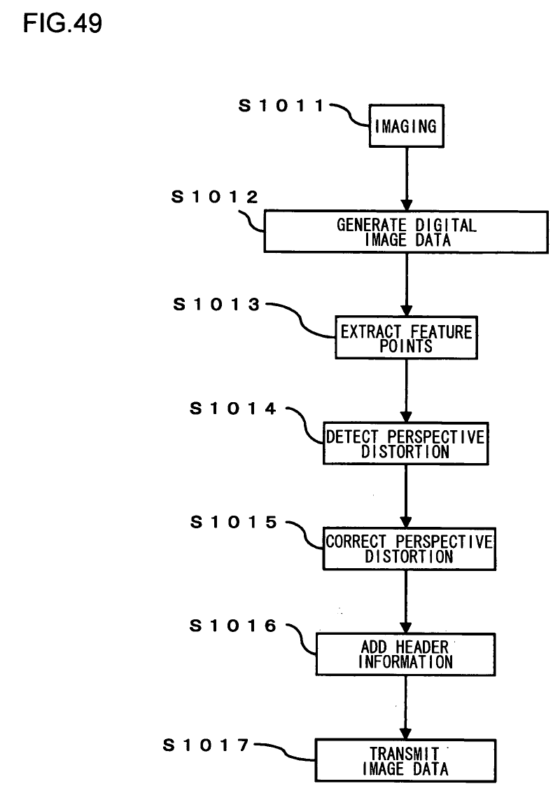

FIG. 49 is a flowchart showing the processing of the camera-equipped cellular phone 1002 according to the present embodiment.

When the client presses down a shutter button on the operation unit 1026, the CCD 1021 performs imaging processing (step S1011). At step S1012, the image processing circuit 1022 performs digital conversion processing on the imaging data.

At step S1013, the feature point detection unit 1027 performs processing for detecting feature points of the area of the watermarked product image 1007 (here, four feature points lying at the four corners of the frame of the watermarked product image 1007) from the digital image data generated by the image processing circuit 1022.

At step S1014, the perspective distortion detection unit 1028 detects perspective distortion of the digital image data. At step S1015, the perspective distortion correction unit 1029 corrects the perspective distortion of the digital image data detected by the perspective distortion detection unit 1028.

At step S1016, the header adding unit 1030 adds the information on the perspective distortion detected by the perspective distortion detection unit 1028 to the header area of the digital image data whose perspective distortion is corrected by the perspective distortion correction unit 1029.

At step S1017, the transmitter-receiver unit 1025 performs processing for transmitting the digital image data having the information on the perspective distortion added by the header adding unit 1030 to the server 1001.

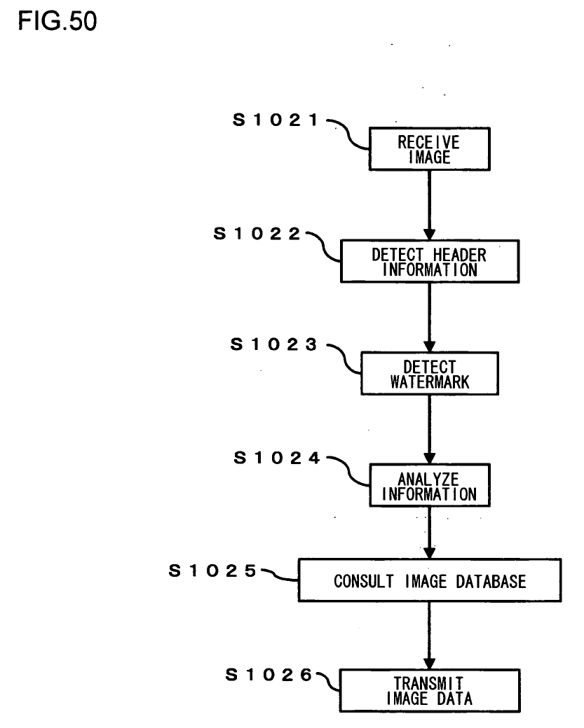

FIG. 50 is a flowchart showing the processing of the server 1001 according to the present embodiment.

At step S1021, the transmitter-receiver unit 1011 receives digital image data transmitted from the camera-equipped cellular phone 1002. At step S1022, the header information detection unit 1019 detects perspective distortion information stored in the header area of the digital image data transmitted from the camera-equipped cellular phone 1002.

At step S1023, the watermark extraction unit 1015 extracts information embedded by the electronic watermark technology from the digital image data received by the transmitter-receiver unit 1011.

At step S1024, the image data indexing unit 1017 is consulted with the information extracted by the watermark extraction unit 1015 and the information perspective distortion information detected by the header information detection unit 1019 as index keys. In consequence, the type of two-dimensional image data requested by the user is identified.

At step S1025, the image database 1016 is consulted to acquire the two-dimensional image data identified at the foregoing step S1024.

At step S1026, the transmitter-receiver unit 1011 performs the processing for transmitting the two-dimensional image data acquired from the image database 1016 to the camera-equipped cellular phone 1002.

According to the present embodiment, perspective distortion is detected and corrected by the client terminal. As compared to the third embodiment, this can reduce the load on the server which is in charge of watermark detection.

### Modification 1 of Fourth Embodiment

In the fourth embodiment, the client terminal performs both detection and correction of perspective distortion. Instead, the client terminal may perform detection of perspective distortion alone, so that the correction is committed to the server side. In such cases, when the terminal determines that the perspective distortion included in the digital image data is too high, it may display a message on the LCD, requesting the client to recapture, instead of transmitting the image data to the server.

### Modification 2 of Fourth Embodiment

In the fourth embodiment, perspective distortion is detected and corrected by the client terminal while electronic watermarks are extracted on the server side. Instead, the extraction of electronic watermarks may also be performed by the client terminal. Here, the information embedded by the electronic watermark technology (product identification information) and the information on the detected perspective distortion (information corresponding to the desired point of view of the client) are transmitted from the client terminal to the server. The server determines the type of two-dimensional image data to provide to the client based on the product identification information and the information on the desired point of view of the client which are transmitted from the client terminal.

### Modification 3 of Fourth Embodiment

The client terminal according to the foregoing modification 2 of the fourth embodiment may further comprise an image database. Then, based on the information embedded by the electronic watermark technology (product identification information) and the information on the detected perspective distortion (information corresponding to the desired point of view of the client), the client terminal may select an image from the image database and display the selected image on its display unit. Alternatively, a thumbnail of the selected image may be displayed on the display unit.

### Fifth Embodiment

In the third and fourth embodiments, the client can acquire two-dimensional image data on a product as viewed from a desired point of view by capturing a watermarked product image while tilting the camera according to the point of view.

In the present embodiment, the client can select optional features of a product to purchase (the type of wrapping paper) by capturing a watermarked product image.

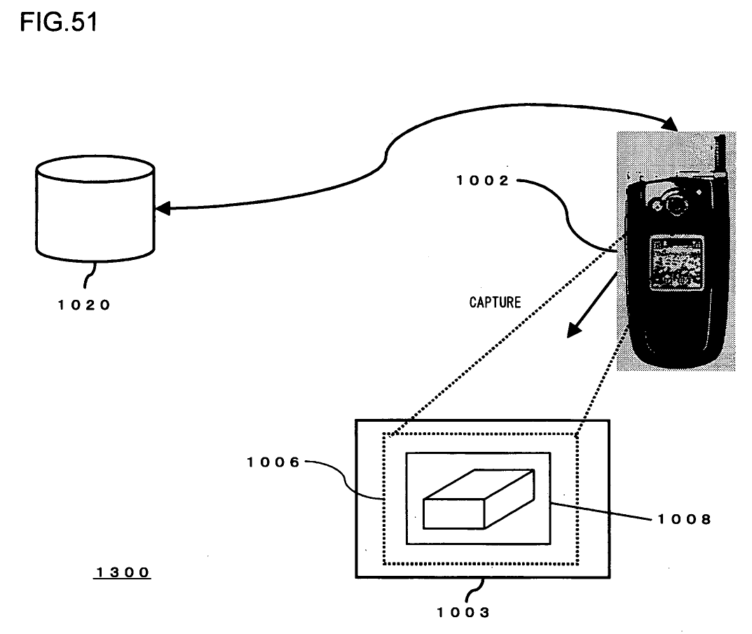

FIG. 51 is a block diagram of a product purchase system 1300 according to the present embodiment. The product purchase system 1300 comprises a server 1020, a camera-equipped cellular phone 1002, and a printed material 1003.

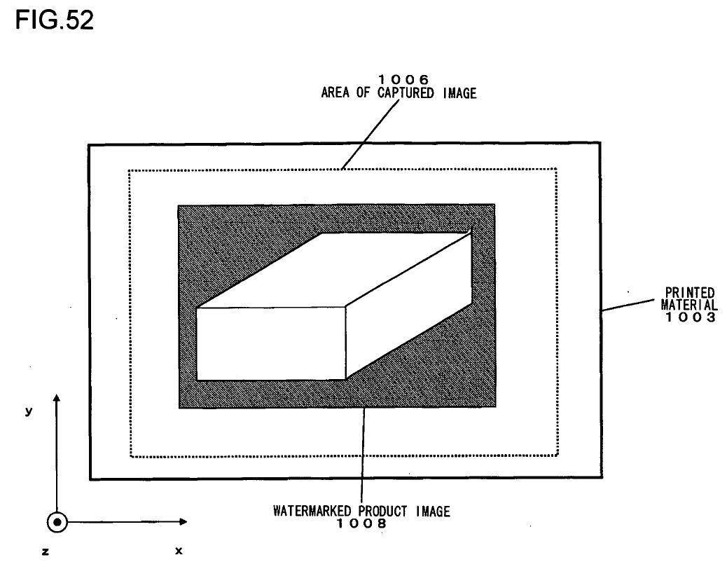

Referring to FIG. 52, a watermarked product image 1008 is printed on the printed material 1003. In the following description of the present embodiment, as in the third embodiment, the horizontal direction of the watermarked product image 1008 will be referred to as x direction, and the vertical direction of the watermarked product image 1008 as y direction. The direction perpendicular to the watermarked product image 1008, piercing the image from the back to the front, will be referred to as z direction.

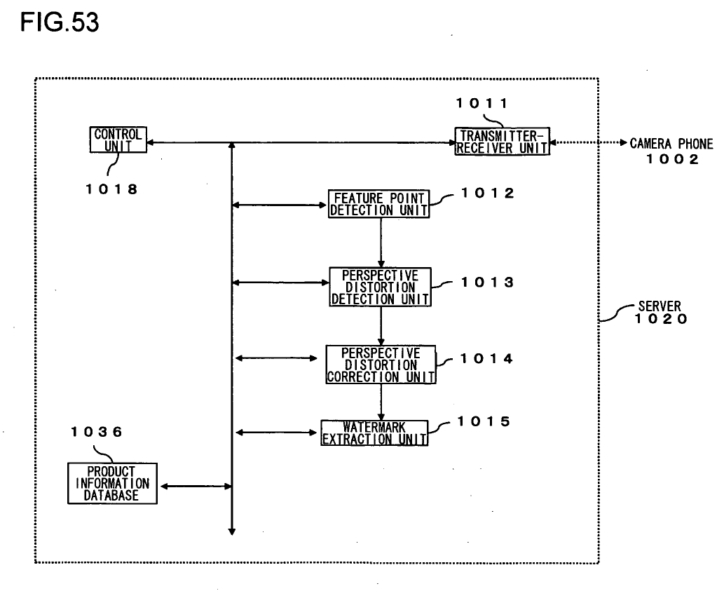

FIG. 53 is a block diagram of the server 1020 according to the present embodiment. The server 1020 comprises such components as a transmitter-receiver unit 1011, a feature point detection unit 1012, a perspective distortion detection unit 1013, a perspective distortion correction unit 1014, a watermark extraction unit 1015, a product information database 1036, and a control unit 1018. The transmitter-receiver unit 1011, the feature point detection unit 1012, the perspective distortion detection unit 1013, the perspective distortion correction unit 1014, the watermark extraction unit 1015, and the control unit 1018 are the same as those of the server 1001 according to the third embodiment. Detailed description thereof will thus be omitted.

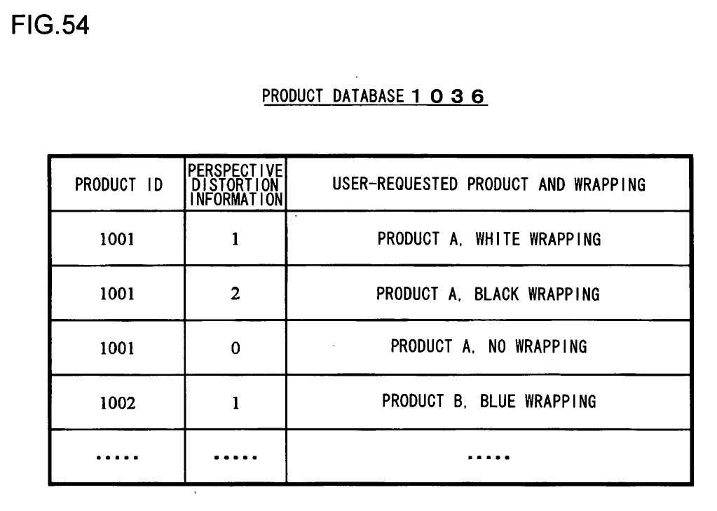

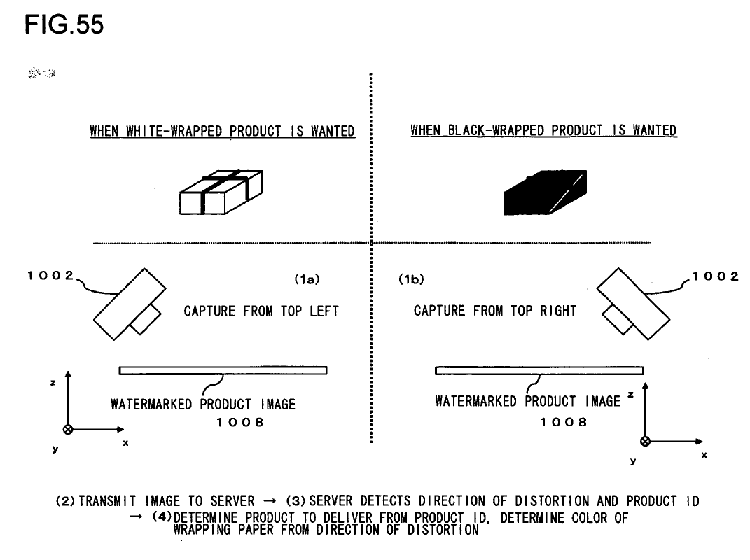

FIG. 54 shows the contents of the product database 1036 in the server 1020 of the present embodiment. The product database 1036 contains product-related information with product ID and perspective distortion information as two index keys. In the present embodiment, the products shall be gift products. Product IDs are ones corresponding to the types of the products (models, forms, or the like). The perspective distortion information pertains to the colors of wrapping paper for wrapping the products. FIG. 55 is a conceptual diagram of the product purchase system 1300 according to the present embodiment. When a client who wants to purchase a product wants the product wrapped in white wrapping paper, the client captures the watermarked product image 1008 placed on the x-y plane from top left (“−x, +z” side) by using a camera with communication facilities (the camera-equipped cellular phone 1002) (see FIG. 55(1a)). The watermarked product image 1008 contains a product ID which is embedded in the form of an electronic watermark.

When the client who wants to purchase the product wants the product wrapped in black wrapping paper, the client captures the watermarked product image 1008 from top right (“+x, +z” side) by using the camera-equipped cellular phone 1002 (see FIG. 55(1b)).

The captured image is subjected to digital conversion processing, and the resulting digital image data is transmitted to the server 1001 (see FIG. 55(2)). The perspective distortion correction function 1014 of the server 1020 corrects perspective distortion of the digital image data based on the information on the perspective distortion detected by the perspective distortion detection unit 1013. Next, the watermark extraction unit 1015 extracts the information on the product ID embedded in the form of the electronic watermark from the perspective-distortion-corrected digital image data (see FIG. 55(3)). Then, based on the product ID information and the perspective distortion information, the server 1020 consults the product information database 1036 and determines the product to deliver to the client and its wrapping method (see FIG. 55(4)).

In this way, the product purchase system 1300 according to the present embodiment makes it possible for clients to select the colors of wrapping paper for products by means of the capturing angles.

### Modification of Fifth Embodiment

In the foregoing embodiment, the client selects the color of the wrapping paper for the product, whether black or white, by capturing the printed mater 1003 from obliquely above (in either one of two directions). The client who uses the product purchase system 1300 may also select the color of the wrapping paper other than black and white by capturing the printed material 1003 in directions other than described in the foregoing embodiment.

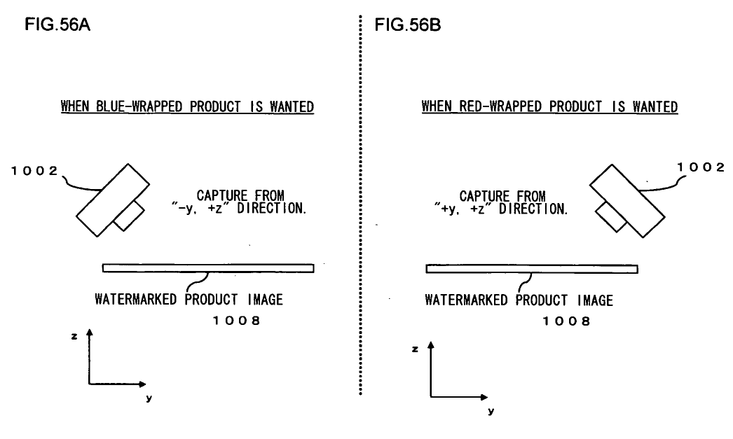

For example, when the client who wants to purchase the product wants the product wrapped in blue wrapping paper, he/she captures the watermarked product image 1008 from “+z, −y” side by using the camera-equipped cellular phone 1002 (see FIG. 56A). When the client who wants to purchase the product wants the product wrapped in red wrapping paper, the client captures the watermarked product image 1008 from “+z, +y” side by using the camera-equipped cellular phone 1002 (see FIG. 56B).

In these cases, the capturing direction can be detected by the same method as in modification 1 of the third embodiment, described with reference to FIG. 45.

### Sixth Embodiment

The capturing angle of a camera may be utilized as a means for indicating client's intention in an interactive system.

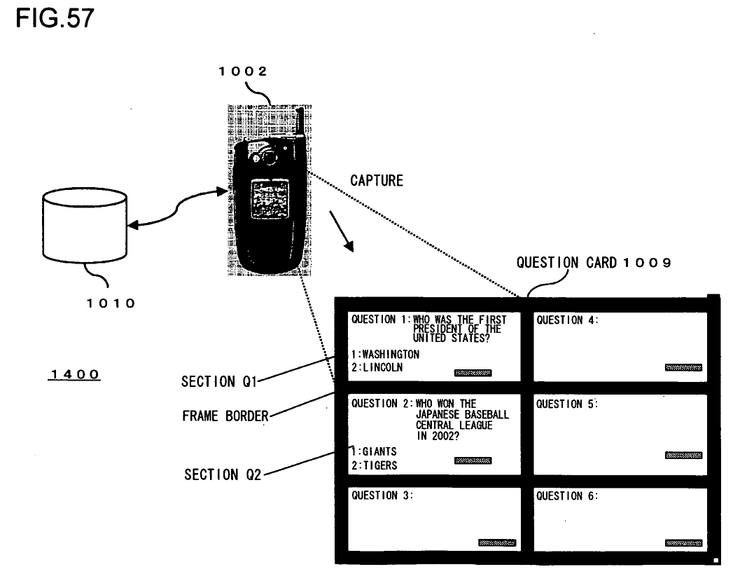

FIG. 57 is a diagram showing the configuration of a quiz answering system 1400, which is an example of such an interactive system. The quiz answering system 1400 comprises such components as a server 1010, a camera-equipped cellular phone 1002, and a question card 1009.

The client changes the capturing angle of the camera-equipped cellular phone 1002 when capturing the question card 1009, thereby answering the quiz printed on the question card 1009. The question cars 1009 has quiz questions printed thereon, and is divided into sections corresponding to the questions. For example, question 1 is printed on the section Q1 of the question card 1009. Question 2 is printed on the section Q2 of the question card 1009. In each of the sections Q1, Q2, . . . , the identification number of the question card 1009 and the number of the quiz question are embedded in the form of electronic watermarks. For example, the identification number of the question card 1009 and the information indicating that the quiz question number is 1 are embedded in the section Q1 in the form of electronic watermarks.

Each section of the question card is bordered with a thick frame, so that the server 1010 can detect perspective distortion of the captured image from the distortion of the frame appearing on the captured image.

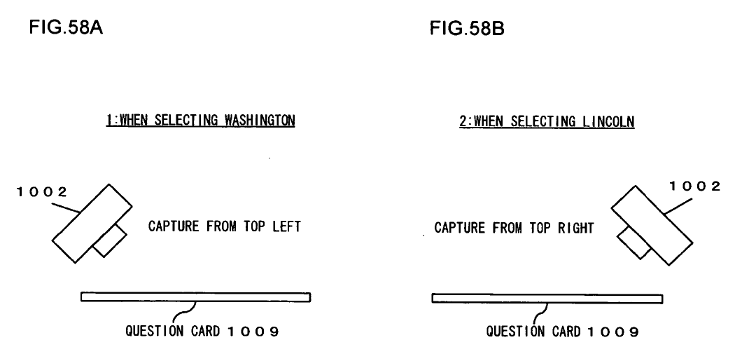

Description will now be given of an example of client operations in such a quiz answering system 1400. For question 1 of the question card 1009 in FIG. 57, asking “Who was the first president of the United States?”, the client captures the section Q1 of the question card 1009 from top left as shown in FIG. 58A when selecting “1: Washington.” When selecting “2: Lincoln,” the client captures the section Q1 of the question card 1009 from top right as shown in FIG. 58B.

The digital image data on the question card 1009, captured by the camera-equipped cellular phone 1002, is transmitted to the server 1010. The server 1010 corrects perspective distortion of the digital image data, and stores the direction of distortion (the number of the answer selected by the client) that is detected during this distortion correction. Then, the server 1010 extracts the identification number of the question card 1009 and the quiz question number embedded in the form of electronic watermarks from the distortion-corrected digital image data.

Furthermore, the server 1010 consults a database (a database that contains question numbers and the numbers of the corresponding right answers) based on the quiz question number extracted and the answer number detected, thereby determining if the answer from the client is correct.

Note that the foregoing example has dealt with the case where the question card 1009, a printed material, contains both text information for showing quiz questions and electronic watermark information including quiz question numbers. Instead, the text information for showing quiz questions and the electronic watermark information such as quiz question numbers may appear not on a printed material but on a TV broadcasting screen. According to such an embodiment, it is possible to realize an online quiz show of audience participation type. Moreover, such an embodiment may be applied to telephone polling questionnaires in TV programs.

### OTHER MODIFICATIONS

Other possible modifications include the following:

(1) Application for a restaurant menu: Watermark information is embedded in the pictures of dishes and provisions. The restaurant menu can be captured to display detailed information on dishes, guest reviews, etc. Other information such as the scent of the dishes is also applicable.

(2) Application for a museum guidebook: A museum guidebook can be captured to provide voice or visual descriptions on collections.

In both of the foregoing applications (1) and (2), description languages such as English, Japanese, and French can be switched depending on the capturing angle. For example, an identical watermarked image can be captured obliquely from the front to show Japanese description, and obliquely from behind to show English description. This has the advantage that menus and pamphlets need not be prepared for each individual language.

The foregoing embodiments disclosed herein are to be considered in all respects as illustrative and not restrictive. The scope of the invention is indicated by the appended claims rather than by the foregoing description of the embodiments, and all changes which come within the meaning and range of equivalency of the claims are therefore intended to be embraced therein.

The foregoing embodiments have dealt with the cases where the client captures a watermarked product image obliquely. Nevertheless, the client may put the camera directly above a watermarked image and capture the image with the camera tilted. For example, suppose that the client captures the image while holding the camera as tilted the left side up and the right side down. Then, in the captured image, the left edge of the area of the watermarked image (in FIG. 42, between the first and third feature points) becomes smaller in length than the right edge (in FIG. 42, between the second and fourth feature points). In such cases, the server determines that the client captures the watermarked image from top right (“+z, +x” direction of FIG. 34).

The foregoing embodiments have dealt with the cases where the client captures in oblique directions an image in which product information is embedded by the electronic watermark technology. Instead, the client may obliquely capture a printed material in which product information is embedded in the form of a one- or two-dimensional barcode. In this case, the electronic watermark extraction unit of the present invention is replaced with a one- or two-dimensional barcode reader.

An information database apparatus may also be provided, comprising: a distortion detection unit for detecting image distortion from imaging data obtained by an imaging device; an information data storing unit for storing information data; and a selector unit for selecting information data stored in the information data storing unit based on the image distortion detected by the distortion detection unit.

### INDUSTRIAL APPLICABILITY

The present invention is applicable to the field of image processing.

1. An image correction apparatus comprising:
a lens distortion calculation unit which acquires information on zoom magnifications contained in data of known images captured at respective different zoom magnifications, and calculates lens distortion correction information with respect to each zoom magnification; and
a storing unit which stores the lens distortion correction information in association with the zoom magnifications.

2. An image correction apparatus comprising:
a storing unit which contains lens distortion correction information in association with zoom magnifications of a lens;
a selection unit which acquires from data of an input captured image, information on a zoom magnification employed at the time of capturing of the captured image, and selects lens distortion correction information corresponding to the zoom magnification from the storing unit; and
a distortion correction unit which corrects distortion of the captured image ascribable to capturing based on the lens distortion correction information selected.

3. The image correction apparatus according to claim 2, wherein
the selection unit selects from the storing unit a plurality of candidate pieces of lens distortion correction information in accordance with the zoom magnification employed at the time of capturing, and correct a row of sample points forming a known shape in the captured image by using each of the plurality of pieces of lens distortion correction information for error pre-evaluation, and thereby selects one piece of lens distortion correction information from among the plurality of pieces of lens distortion correction information.

4. An image correction apparatus comprising:
a lens distortion calculation unit which acquires information on zoom magnifications contained in data of known images captured at respective different zoom magnifications, and calculates a lens distortion correction function for mapping points in a lens-distorted image onto points in an image having no lens distortion and a lens distortion function, or an approximate inverse function of the lens distortion correction function, with respect to each lens magnification; and
a storing unit which stores the pairs of lens distortion correction functions and lens distortion functions in association with the zoom magnifications.

5. An image correction apparatus comprising:
a storing unit which contains pairs of lens distortion correction functions for mapping points in a lens-distorted image onto points in an image having no lens distortion and lens distortion functions, that are approximate inverse functions of the lens distortion correction functions, in association with respective zoom magnifications of a lens;
a selection unit which acquires from data of an input captured image, information on a zoom magnification employed at the time of capturing of the captured image, and selects from the storing unit the lens distortion function corresponding to the zoom magnification; and
a distortion correction unit which corrects distortion of the captured image ascribable to capturing based on the lens distortion function selected.

6. The image correction apparatus according to claim 5, wherein
the selector unit selects from the memory unit a plurality of candidate lens distortion correction functions in accordance with the zoom magnification employed at the time of capturing, and corrects a sequence of sample points forming a known shape in the captured image by using each of the plurality of lens distortion correction functions for error pre-evaluation, and thereby selects one of the plurality of lens distortion functions.

7. An image correction apparatus comprising:
a storing unit which contains lens distortion functions for mapping points in an image having no lens distortion onto points in a lens-distorted image in association with respective zoom magnifications of a lens;
a selection unit which acquires from data of an input captured image, information on a zoom magnification employed at the time of capturing of the captured image, and selects the lens distortion function corresponding to the zoom magnification from the storing unit;
a perspective distortion calculation unit which calculates a perspective distortion function for mapping points in an image having no perspective distortion onto points on a perspective-distorted image, by using an image whose lens distortion is corrected by the lens distortion function selected; and
a distortion correction unit which corrects distortion of the captured image ascribable to capturing based on the perspective distortion function calculated by the perspective distortion calculation unit.

8. The image correction apparatus according to claim 7, wherein
the selector unit selects from the memory unit a plurality of candidate lens distortion correction functions in accordance with the zoom magnification employed at the time of capturing, and corrects a sequence of sample points forming a known shape in the captured image by using each of the plurality of lens distortion correction functions for error pre-evaluation, and thereby selects one of the plurality of lens distortion functions.

9. An image correction database creating method comprising:
acquiring information on zoom magnifications contained in data of known images captured at the respective different zoom magnifications, and calculating a lens distortion correction function for mapping points on a lens-distorted image onto points on an image having no lens distortion and a lens distortion function, or an approximate inverse function of the lens distortion correction function, with respect to each lens magnification; and
registering the pairs of lens distortion correction functions and lens distortion functions into a database in association with the zoom magnifications.

10. An image correction method comprising:
consulting a database in which pairs of lens distortion correction functions for mapping points in a lens-distorted image onto points in an image having no lens distortion and lens distortion functions, that are approximate inverse functions of the lens distortion correction functions, are registered in association with respective zoom magnifications of a lens, acquiring from data of an input captured image, information on a zoom magnification employed at the time of capturing of the captured image, and selecting the lens distortion function corresponding to the zoom magnification; and
correcting distortion of the captured image ascribable to capturing based on the lens distortion function selected.

11. The image correction method according to claim 10, wherein
the correcting of the distortion includes:
mapping a point in a target image having no distortion ascribable to capturing onto a point in a lens-distorted captured image by using the lens distortion function selected which was selected from the image correction database; and
determining a pixel value at the point in the target image by interpolating pixel values near the mapped point in the captured image.

12. The image correction method according to claim 10 or 11, wherein
the selecting of the lens distortion function includes: selecting a plurality of lens distortion correction functions as candidates in accordance with the zoom magnification employed at the time of capturing; correcting a row of sample points having a known shape in the captured image by each of the plurality of lens distortion correction functions for error pre-evaluation; and selecting one from among the plurality of lens distortion functions.

13. An image correction method comprising:
consulting a database in which lens distortion functions for mapping points in an image having no lens distortion onto points in a lens-distorted image are registered in association with respective zoom magnifications of a lens, and acquiring from data of an input captured image, a zoom magnification employed at the time of capturing of the captured image and selecting the lens distortion function corresponding to the zoom magnification;
calculating a perspective distortion function for mapping points in an image having no perspective distortion onto points in a perspective-distorted image, by using an image whose lens distortion is corrected by the lens distortion function selected; and
correcting distortion of the captured image ascribable to capturing based on the perspective distortion function calculated.

14. The image correction method according to claim 13, wherein
the correcting of the distortion includes:
mapping a point in a target image having no distortion ascribable to capturing onto a point in a perspective-distorted captured image by using the perspective distortion function calculated; and
determining a pixel value at the point in the target image by interpolating pixel values near the mapped point in the captured image.

15. The image correction method according to claim 13 or 14, wherein
the selecting of the lens distortion function includes: selecting a plurality of lens distortion correction functions as candidates in accordance with the zoom magnification employed at the time of capturing; correcting a row of sample points having a known shape in the captured image by each of the plurality of lens distortion correction functions for error pre-evaluation; and thereby selecting one from among the plurality of lens distortion functions.

16-24. (canceled)
